(19) United States
(12) Patent Application Publication
(10) Pub. No.: US 2018/0293898 A1
(43) Pub. Date: Oct. 11, 2018

(54) METHOD AND APPARATUS FOR ALLOCATION OF AIR SPACE FOR UNMANNED AERIAL VEHICLES

(71) Applicant: THOMSON Licensing, Issy-les-Moulineaux (FR)

(72) Inventors: William Gibbens REDMANN, GLENDALE, CA (US); Joel FOGELSON, Pasadena, CA (US)

(21) Appl. No.: 15/758,872

(22) PCT Filed: Sep. 9, 2015
(86) PCT No.: PCT/US2015/049075

§ 371 Date: Mar. 9, 2018

(51) Int. Cl. G08G 5/00

(52) U.S. Cl. CPC G08G 5/006; G08G 5/0069; B64C 39/024; G08G 5/0013; G08G 5/0026

(57) ABSTRACT

A method for automatically managing air space for at least one unmanned aerial vehicle (UAV), includes receiving a request associated with the at least one UAV, the request having at least one associated characteristic associated with UAV operation, to access a defined air space having at least one associated requirement. A determination then occurs whether the at least defined air space to be accessed by the UAV is available and if the at least one characteristic of the at least one UAV matches the at least one requirement of the defined air space. If so, then a license is granted to the UAV to authorize to entry of the UAV into the defined air space.

### TECHNICAL FIELD

This disclosure relates to allocation of space for access by unmanned aerial vehicles (UAVs), especially allocation of air space for unmanned aerial vehicles.

### BACKGROUND ART

Advances in technology have led to the development of commercially available unmanned aerial vehicles, usually referred to as UAVs or drones. Originally, the UAVs remained the province of Governmental agencies, especially, the armed forces. Now, various vendors offer the UAVs to the public. Until recently, UAVs could not be used for commercial purposes in the United States, although now the Federal Aviation Administration (FAA) has begun accepting petitions for exceptions. The online merchant Amazon has petitioned to use UAVs for autonomous delivery of merchandise. News gathering agencies have petitioned to use UAVs at the scene of newsworthy events. The film industry has petitioned to use UAVs while filming movies and television shows on location.

Classically, air rights associated with movement of manned aircraft depends on the air craft's altitude. Traditionally, rather than by any explicit agreement among nations, “outer space” starts somewhere between 50 and 62 miles (100 km) above mean sea level. Currently, no international agreements govern outer space. Unlike outer space, control of “airspace” remains subject to international agreements. Generally, a country's “airspace” covers the country's land mass and territorial waters, and extends upwards therefrom to outer space. Many international treaties exist that grant or restrict certain “freedoms of the air” ranging from transit through another country's airspace without landing (the most widely granted freedom of the air) to operating passenger service two destinations with a foreign country, e.g., a Canadian company operating a shuttle in Italy between Rome and Milan (a freedom rarely granted).

Within the United States, the Federal Aviation Administration (FAA) controls airspace rights. In this regard, the FAA has defined navigable airspace as “airspace above the minimum altitudes of flight”. In the U.S., the FAA mandates aircraft fly at least 1000 feet (300 m) above obstacles within 2,000 feet (610 m) of the aircraft. In non-congested, sparsely populated areas, or over water, the FAA has relaxed this restriction; requiring aircraft fly at least 500 feet (150 m) above any person, vehicle, vessel, or structure. Necessarily, FAA rules reduce such limits during aircraft takeoff and landing (see 14 C.F.R. § 60.17). Other countries impose their own regulations regarding minimum distances at which aircraft must fly above any obstacle (buildings, antenna, etc.) near the aircraft.

Presently, US Law provide that owners of real property own the air rights between the ground and navigable airspace, US courts have held that rights to such airspace belong to the owner of the land beneath the airspace. In this regard, property owners can sell or otherwise convey such “air rights” similar to granting easements. Often “air rights” relate to development rights in the field of real estate, and are often granted or acquired as an easement. Municipalities or other governmental entities typically own the air rights over roadways and bridges, and in some cases, such agencies will offer such air for private use.

Commercial UAV use will likely proliferate over time. Even at the present low level of UAV operation, issues can likely arise. Currently, no mechanism exists for controlling UAV access to private air space so nothing would prevent a commercial UAV from flying though such private air space, thus interfering with activities on the land therebelow. Moreover, no mechanism currently exists for preventing two or more UAVs from flying within the same air space at the same time, potentially risking a mid-air collision or interfering with manned aircraft.

Thus, a need exists for an automatic mechanism for providing fast and secure management of a rapid stream of requests for permission to access specific airspaces by UAVs.

### BRIEF SUMMARY

A method for automatically managing air space for at least one unmanned aerial vehicle (UAV), includes receiving a request associated with the at least one UAV having at least one associated characteristic associated with UAV operation to access a defined air space having at least one associated requirement. A determination then occurs whether the at least defined air space to be accessed by the UAV is available and if the at least one characteristic of the at least one UAV matches the at least one requirement of the defined air space. If so, then clearance, in the form of an air block license is granted to the UAV to authorize to entry of the UAV into the defined air space.

### BRIEF DESCRIPTION OF THE DRAWINGS

FIG. 1 depicts a block diagram of a system for providing time-limited licenses for near-ground air rights for UAVs and the like over public and/or private property in a region;

FIG. 2 depicts a map showing exemplary paths available for authorization for UAV flights;

FIG. 3 depicts a perspective view of a neighborhood represented by the map of FIG. 2, showing airspace volumes;

FIG. 4 depicts another map showing exemplary authorized flightpaths, authorized operating areas, and prohibited areas for UAV flights;

FIG. 5 depicts an exemplary schema for a database to support air blocks, ownership, licensing, and routing for UAV flights;

FIG. 6 depicts transaction diagram for remotely controlling a UAV, where a controller obeys the constraints of air block licenses;

FIG. 7 depicts transaction diagram for directing a UAV, where the UAV autonomously obeys the constraints of air block licenses;

FIG. 8 depicts an alternative transaction diagram for indirectly controlling a UAV through a UAV management system that operates subject to the constraints of air block licenses;

FIG. 9A depicts a flowchart diagram illustrating the steps of a method of operation performed by a UAV, for use in connection with the transaction operation of FIG. 7;

FIG. 9B depicts flowchart diagram illustrating the steps of a method of operation performed by a UAV, for use in connection with the transaction operations of FIG. 8 and/or 9;

FIG. 10 depicts flowchart diagram illustrating the steps of for a method of operation performed by a UAV management system;

FIGS. 11A-D depict exemplary user interfaces provided by an air block manager, in which

FIG. 11A depicts a display of information about a specific air block;

FIG. 11B depicts a display of license policies for a specific air block;

FIG. 11C depicts a display of reports for license usage for a specific air block; and

FIG. 11D is for making manual requests for licenses to use a specific air block;

FIG. 12 depicts a flowchart for a method of operation performed by an air block license server;

FIG. 13 depicts an exemplary activity request for air block licenses;

FIGS. 14A-E collectively depicts an exemplary embodiment of a successful route reply message granting air block licenses; and,

FIG. 15 depicts an exemplary route reply message for a request not granted.

### DETAILED DESCRIPTION

As described hereinafter, a systems serves to manage air space for unmanned aerial vehicles (UAVs), sometimes referred to as drones. For proposes of discussion, “Superadjacent airspace” refers to the airspace that is immediately above an area of land up the beginning of navigable airspace, which in the United States is generally defined as 500 ft. above the surface or objects on the surface (e.g., buildings, trees or other structures, man-made or natural). Other jurisdictions may have different specifications for navigable airspace. Within the same jurisdiction, more limiting restrictions can exist, for example, with regard to the air space in proximity to airports, where regulations stipulate lower altitudes for navigable airspace used by aircraft taking off or landing.

Typically, owners of real property (i.e., “land”) also own rights the superadjacent airspace, though in some cases, a previous owner may might have transferred air rights to another entity or otherwise encumbered such rights to the detriment of the present owner. In some cases, the entity which has become the recipient of such air rights, will manage such rights separately regarding use and enjoyment of the underlying property.

As used herein, an “air block” defines a volume that encompasses all of, or a particular portion of, the superadjacent airspace of an underlying property, where each air block can constitute the subject of a separately license for use. The superadjacent airspace of an underlying property can undergo division into multiple air blocks, which are generally mutually exclusive of each other, such that a license to any one such air block represents an authorization granting exclusive access to that air block. For example, an air block could describe the entire superadjacent airspace of a property so access to the air block would correspond to access to the entire underlying property. Alternatively, that airspace could undergo division into multiple air blocks, each coextensive with the property boundaries, but encompassing different altitude ranges, e.g., 0-100 feet, 100-200 feet, 200-300 feet, 300-400 feet, and 400-500 feet. This would allow independent licensing of each air block. To avoid a potential risk of collision at the boundaries of two vertically adjacent air blocks, the licenses could impose a no-flight buffer region or could impose time constrains precluding access to two vertically adjacent bocks at the same time. In addition to, or in place of dividing the air space vertically, horizontal division of the air space can also occur. Thus for example, separate air blocks could exist coextensive with the northern and southern halves of the property or even over smaller sections that need not necessarily encompass the same areas.

Such multiple air blocks, regardless of their manner of division, need not exist mutually exclusive of each other, but can undergo licensing licensed in a manner to ensure that a license to any one such air block includes not only exclusive access to that air block but exclusive access to one or more other blocks adjacent thereto. For example, the grant of a license to a first air block to a first party for a particular interval of time precludes the grant of a license to other air block sharing any volume with the first air block to any different party for the duration of that interval. This makes the license exclusive for use of the first air block. However, a single party could obtain license to contiguous air blocks for the same interval of time, with the proviso that the license remains exclusive to that party.

In still another embodiment, the licensing of air blocks could occur on a non-exclusive basis. However, such non-exclusive access to an air block could require certain levels of the UAV navigational performance such as tightly controlled flightpaths (e.g., a UAV must enter the air block at a specific time and location, proceed at not less than a specific speed, and exit at on or before a specific time and at a specified location). Alternatively, non-exclusive access to an air block could require advanced navigational capabilities such as automatic collision avoidance, vehicle following, formation flying, or other operating capability for safe flight while transiting a non-exclusive air block.

In still another alternative, a plurality of the UAVs could make use of a one or more licenses to the same air block at the same time, (either all using the same license, or each having their own), provided a common entity manages the UAVs, with that entity being responsible in the case that two the UAVs collide. For example, consider a sporting event covered by multiple the UAVs, all operated by an agent of the entity providing the coverage. This entity has the responsibility for managing all of the UAVs regardless of their number. The license(s) issued to that entity precludes the grant of licenses for the same air block(s) for the same interval to other entities that manage the UAVs.

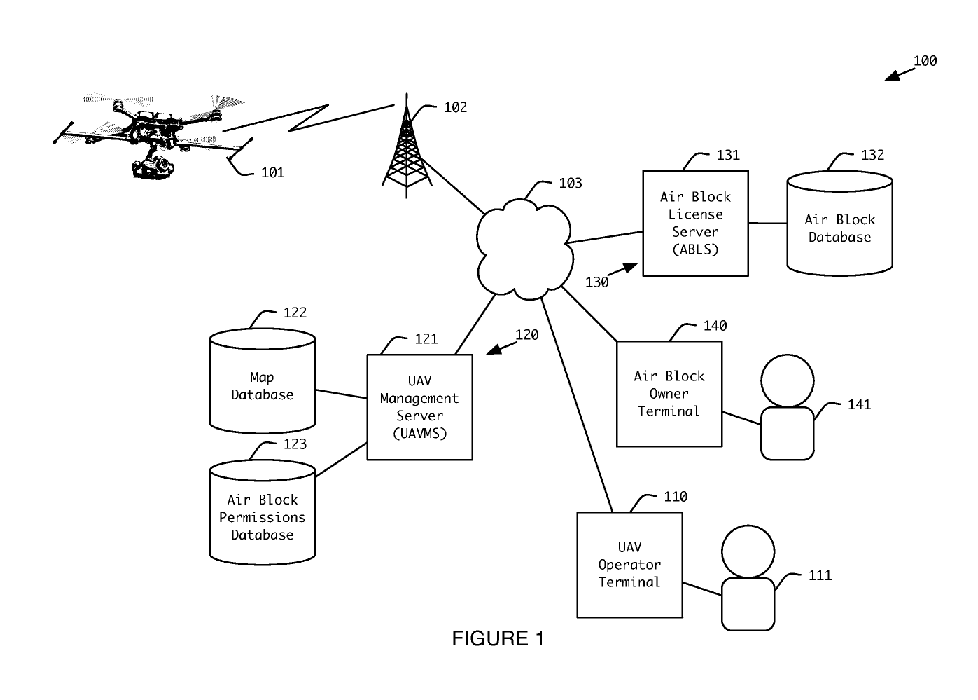

FIG. 1 depicts a block schematic diagram of an air rights licensing system 100, in accordance with a preferred embodiment of the present principles, for providing time-limited licenses for use by the UAVs, such as the UAV 101, to access for air rights over public and/or private property throughout the region managed by the system. The air rights licensing system 100 allows a UAV operator 111 to the direct the UAV 101 with the aid of the UAV manager 120. The UAV manager 120 determines which, if any air block licenses the UAV 101 will need to complete its specified flight path. After determining the needed licenses, the UAV manager 120 interacts with the air block license manager 130 to obtain such air block licenses.

An air rights owner 141, typically the owner of a piece of real property and its corresponding superadjacent airspace, or the transferee of such air rights, if transferred, provides information for entry into an air block owner terminal 140 to define one or more air block(s) and to register terms for use for each such block. The terminal 140 communicates that information to air block license manager 130 across a network 103, such as, but not limited to, the Internet for receipt by an Air Block License Server (the ABLS) 131. For example, an air right owner could choose to define a single air block coextensive with the underlying property, or could define multiple air blocks encompassing separate areas of the property. An air block license database in 132 connected to the air block license server 131 records information about each as so defined, as well as the terms for use corresponding to each air block, for example the time availability and cost. In some embodiments, the ABLS 131 could comprise an HTTP server and air block owner terminal 140 could take the form of a web browser directed to the ABLS 131.

The management and operation of the air block license manager 130 could occur as a public function much the same way that government manages the record keeping associated with the transfer of rights in real property. Alternatively, such management could occur as a private function, typically although not necessarily under government supervision. The entity operating the air block license manager 130 could require an in-person interaction where the air rights owner 141 interacts with a clerk, officer, or other agent so that the air rights owner does not directly interact with the air block owner terminal 140, but instead operates through such an agent. This affords an advantage when initializing the air block database 132 with default settings, which could vary according to different zonings. Presumably, individuals working on behalf of the entity operating the air block license manager 130 will have greater familiarity with the various zoning status of properties whose air rights are subject to management by the air block license manager 130. For example, for air blocks corresponding to properties zoned as industrial, the air block license manager 130 might, by default, grant free licenses to the UAVs for purposes related to commercial delivery. For air blocks corresponding to properties zoned as residential, the air block license manager 130, by default might disallow licenses to the UAVs for purposes of commercial photography. As another example, a municipality could grant default licenses to air blocks associated with public spaces for a specified price.

The management and operation of the air block license manager 130 offers an improvement where the data and the definitions of appropriate spaces can be communicated to various UAV in a fast, efficient manner which is not possible before the present disclosures. In addition, the disclosed systems provide UAVs with real time information to prevent collisions between such drones by use of the air block license manager 130

The UAV 101 operates under the control of the UAV operator 111 who enters control instructions via a UAV operator terminal 110 for transmission to the UAV via transceiver 102 linked via network 103 to the UAV operator terminal. The control instructions can include a flight plan, as well as commands specifying one or more the UAV operating parameters, such, but not limited to, time, altitude; airspeed; vertical acceleration; heading, pitch attitude, roll attitude; and longitudinal acceleration. As depicted in FIG. 1, the UAV operator 111 takes the form of a person, but can also include a programmed computer (not shown) or a person assisted by such a programmed computer. The control instructions sent to the UAV 101 can include specific navigation details for execution in real time, e.g., piloting the UAV when used as a flying camera platform for a movie production or for newsgathering. Alternatively, the control instructions could take the form of higher level tasks, for example, a flight plan or portion thereof, for automatic execution by the UAV. In the case of use of the UAV 101 for autonomous package delivery, the control instructions could include the addresses associated with package pick-up and delivery.

As discussed above, the UAV 101 communicates with UAV operator 111 though a wireless connection with a transceiver 102 connected via network 103 to the UAV operator terminal 110. Some embodiments may provide a direct wireless connection between the UAV operator terminal 110 and the UAV 101, whether or not the UAV operator terminal 110 has a connection to Internet 103 for other reasons, as described below.

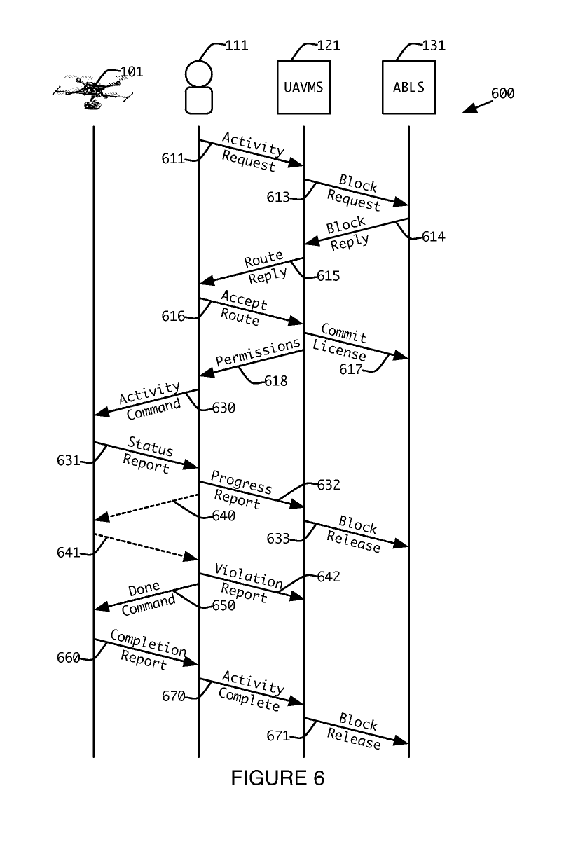

In accordance with the present principles, the UAVs such as the UAV 101 of FIG. 1 must obtain permission to use the one or more air blocks that correspond to air blocks within the intended flight path of that the UAV. To manage air block permissions, the air rights licensing system 100 includes a UAV management system 120 comprised of a UAV management server (the UAVMS) 121 linked to the network 103 for communicating with the UAV operator terminal 110, the Air Block License Server (the ABLS) 131 and the Air Block Owner Terminal 140. The UAVMS 121 enjoys a link to a map database 122, and an air block permissions database 123. Depending on the embodiment, transactions among the UAV 101, the UAV operator terminal 110, the UAV manager 120, and the air block license manager 130, can take different forms, examples of which are discussed below in conjunction with FIGS. 6-8.

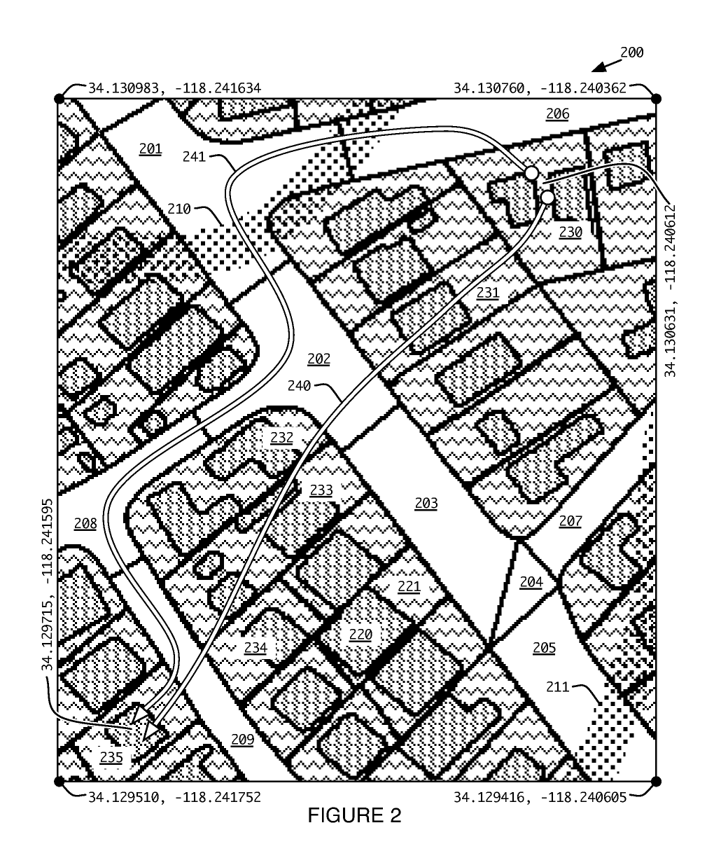

FIG. 2 is a rendering of a portion of an exemplary map 200 as would typically be represented by information within the map database 122 of FIG. 1. The map 200 depicted in FIG. 2 corresponds to a residential neighborhood. The corners of the map 200 include the geographic latitude and longitude coordinates to which such map corners correspond. The broad, white (unhashed) areas of the map 200 correspond to roads, here divided into road segments 201-209. Preferably, the maps, such as the map 200, stored in the database 122 of FIG. 1 include topographic information, represented in the map 200 of FIG. 2 as contour lines 210 and 211, each identifying a line of constant altitude. In the map 200 of FIG. 2, the contour line 210 (shown as a wide, dotted line) represents an elevation of 560 feet above mean sea level, and the contour line 211 represents an elevation of 580 feet above mean sea level, giving the map 200 a contour interval of twenty feet. The non-road regions in the map 200 of FIG. 2 undergo division along property boundaries, indicated by the dark lines. Preferably, the structures (if any) on each property appear as a darker hash, such as the structure 220, whereas the portion(s) of the property that do not include any structures (e.g., lawn, driveways, other landscape) appear as a lighter hash, e.g. hash 221.

In the exemplary map 200, the width of the road segments 201-209 extend out to the right-of-way line of the corresponding road, which in some cases may include a road verge, sidewalk, and/or an easement for utility poles, street lighting, traffic control, fire hydrants or the like. Some maps could include more detail to differentiate among such regions, e.g. to distinguish among sidewalks or easements for utility poles and/or power lines.

The depiction of map 200 includes annotations corresponding to candidate flightpaths 240 and 241 extending from the property 230 (having a designated coordinate) to the property 235 (having a different coordinate), with the direction of the flightpaths indicated by the corresponding arrow heads. The UAVMS 121 of FIG. 1 establishes and evaluates such candidate flight paths, taking into account factors such as distance (shorter being preferred), required performance (less climbing of the UAV being preferred), the availability and cost for obtaining the necessary air block licenses (cheaper licenses generally preferable, but licenses available for a preferred flight window are preferably to licenses available at earlier or later times). Accordingly, each candidate flightpath may have a different utility: A short path could incur a greater expense, as compared to a longer flight path given the increased cost of the needed air block licenses. However, the extra expense could prove justified, taking into account other considerations, such as making a delivery earlier in time or reducing the UAV flight time to avoid the need for recharging of the UAV, etc. The UAVMS 121 generally has the responsibility for selecting among different candidate flightpaths, taking account of various parameters, including but not limited to flight time, license cost, the UAV operating resources, etc. Alternatively, the UAVMS 121 could send such candidate paths to the UAV operator terminal 110 for evaluation and acceptance or rejection as appropriate.

In the example shown, the flightpath 240 takes a relatively direct route, passing from the private property 230, over the private property 231, across the road segment 202 (which is an intersection), over private the properties 232, 233, and perhaps 234, crossing the road segment 209, to arrive at the private property 235. Flightpath 241 has a less direct route, but avoids flight over private properties other than the origin (e.g., the property 230) and the destination (e.g., the property 235). In contrast to the flightpath 240, the flightpath 241 passes from private property 230, over the road segments 206 and 201 (an intersection), road segment 202 (an intersection), road segment 208 (an intersection), and road segment 209, to arrive at private property 235.

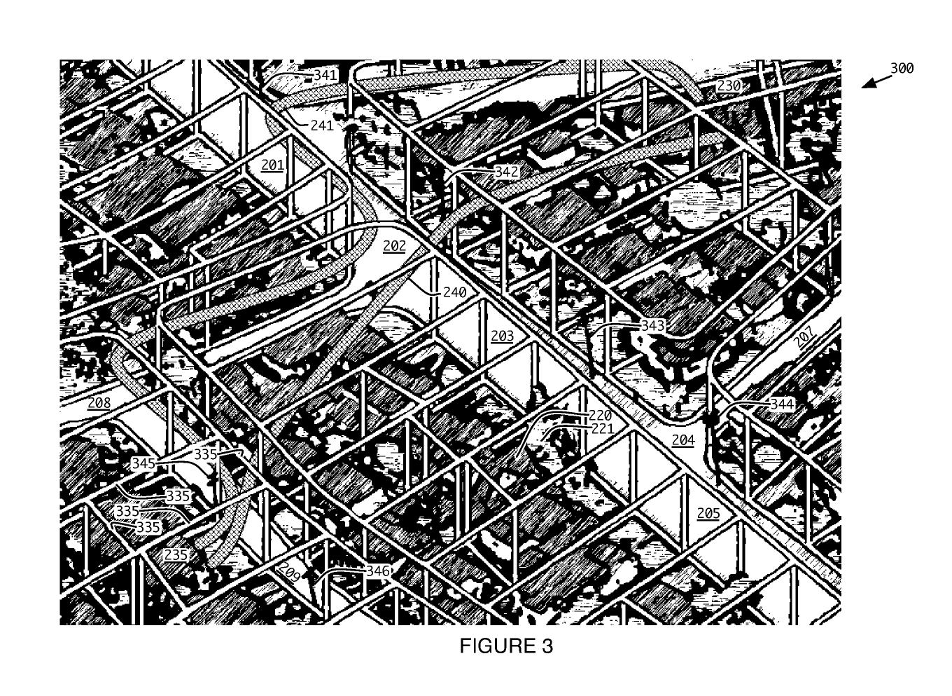

FIG. 3 depicts a perspective view 300 of the physical neighborhood represented in the FIG. 2 rendering of map 200. In FIG. 3, the view 300 is annotated with the boundaries of each piece of private property extending upward to illustrate an air block, as with the air block corresponding to property 235, for which the top of the air block is bounded by the four edges 335. In the view 300, exemplary air blocks run from the ground elevation to a height of 50 feet. The illustrated telephone poles 341-346 have a height of about 35 feet. Structures, such as the structure 220 appear in the view 300 with much of the roof for each structure, but also some of the walls as well. Non-structural portions (e.g., non-structural portion 221) may include trees, shrubs, lawns, driveways, etc. The view 300 omits the air blocks corresponding to the road segments in order to more clearly illustrate the air blocks corresponding to the individual properties. The flightpaths 240 and 241 appear in FIG. 3 to stay within the 50′ height limit of the air blocks illustrated.

In another embodiment, the system 100 of FIG. 1 might reserve some or all of the air blocks up to 50′ as a no-fly zone, other than for departure and landing at the properties 230 and 235, respectively, of FIG. 2. In such a case, the UAV 101 of FIG. 1 would make use of a set of air blocks (not depicted) that range from 50-100′ (or some other height interval), with corresponding flightpaths that first ascend to an appropriate height over the property 230 of FIG. 1. The UAV 101 would then head at the higher height along the selected flightpath to the property 235 of FIG. 2 at which location the UAV would descend.

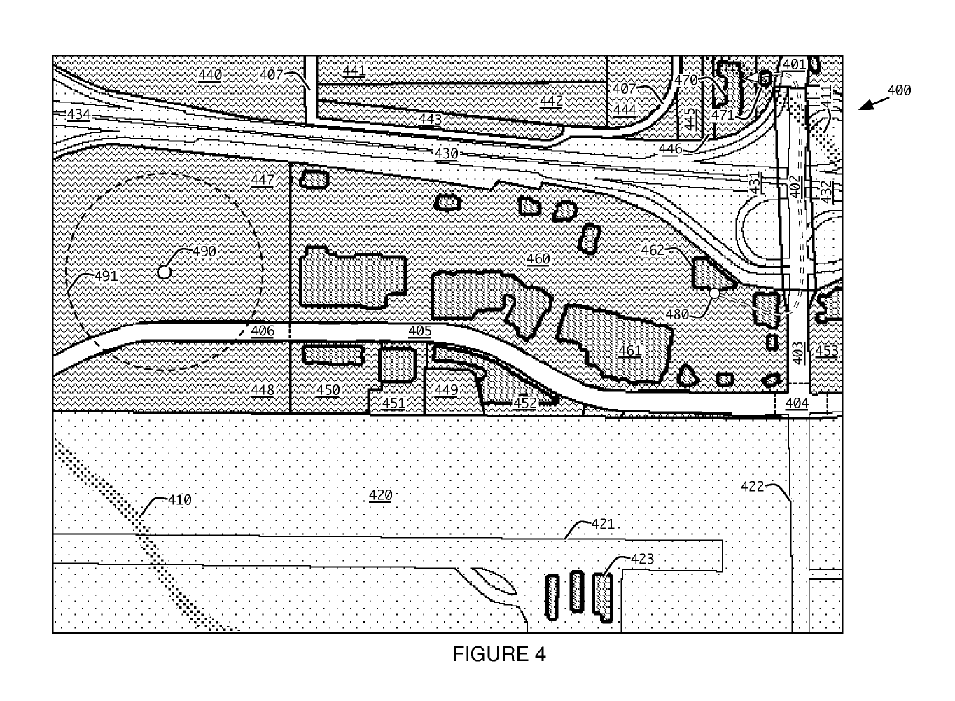

Another exemplary map 400 appears in FIG. 4 and depicts an airport no-access zone 420 and a highway no-access zone 430. The Airport no-access zone 420 comprises a road segment 422, an airport runway 421, and one or more airport buildings 423. The Air Block Owner terminal 140 will initially designate such regions as off-limits to the UAVs to preclude any the UAV flights that might threaten aircraft where navigable airspace lies closer to the ground than 500 feet. The contour lines 410 and 411 in FIG. 4, like the contour lines 210 and 211 in FIG. 2 indicate constant altitude.

The Highway no-access zone 430 protects a highway from the UAV overflights, and includes an interchange 434 and the interchange on opposite sides 431 and 432 of the road segment 402 crossing over the highway. The road segments 401-407 appear in FIG. 4 with the road segment 402 being the only allowed connection between middle portion of the map (the portion immediately above the airport no-access zone 420) and the top portion of the map (the portion immediately above the highway no-access zone 430).

A variety of individual properties also appear in FIG. 4: Properties 440-449 have no structures and typically include vacant lots or farmland. The properties 450-453 each include one structure. The shopping center property 460 has many buildings, including, for example, a department store 461, and pizza restaurant 462. A flightpath 480 appears in FIG. 4 beginning at the pizza restaurant 462 and proceeding across a portion of the shopping center 460 to the road segment 403. The flightpath 480 passes over a bridge that spans a highway over the road segment 402 and road segment 401 and also passes over a gas station 471 to enable a UAV, such as the UAV 101 of FIG. 1 following this flightpath to make a delivery to a hotel 470.

The exemplary flightpath 480 of FIG. 4 suggests good management of the superadjacent airspace of the shopping center 460 demands subdividing such airspace into multiple air blocks, each individually licensable. Otherwise, the relatively minor incursion that flightpath 480 makes over the property 460 would occupy the entirety of the superadjacent airspace for the duration of its license and thus would preclude UAV access to or from other individual stores in the shopping center, such as department store 461. In the context of the department store 461, unavailability of an air block license for a few minutes because of UAV pick-up of a pizza for subsequent deliver would not pose a terrible burden on department store operations. However, for the pizza restaurant 462, the unavailability of an air block license for an extended period of time could drastically affect the quality of delivered product, as could occur if the department store 461 had an outbound delivery of socks followed by another delivery of a birthday gift.

FIG. 4 also illustrates another kind of UAV use other than flightpaths 240, 241 and 480 associated with UAV overflights. The operation area 491 depicted in FIG. 4 appears as a circle centered at a location 490. The operation area correspond to the location of an outdoor scene filmed as part of a movie production or as part of a news gathering activity. The operation area 491 intersects with the superadjacent airspace of the properties 445 and 446 as well as the road segment 406. As discussed above, for some embodiments, the air block licenses granted for the UAV overflights of an area of operation, such as the operating area 491 can cover more than one of the UAVs, where multiple UAVs operate under the management of a common entity responsible for all such UAVs.

Note that the operation area 491, as depicted in FIG. 4, cuts across the road segment 406. In some embodiments, this would preclude licensing of any air blocks for the road segment 406 until release or expiration of the air block license associated with the operation area 491. In other embodiments, a separate air block license could exist for a particular stratum of the superadjacent airspace above the road segment 406 available for UAVs not otherwise associated those operating under common control within the with operation area 491. In still another embodiment, in lieu of an air block license for access along the road segment 406, an air block corresponding to that portion of the property 448 outside the operation area 491 could be licensed, allowing the UAVs not otherwise associated with those operating in the operation area 491 to skirt that area, yet still access the road segment 405 and the property 450 and other nearby areas.

In some embodiments, allocation (e.g., definition) of an air block could occur dynamically to encompass the intersection of the superadjacent airspace of a property with an area of operation (e.g., operation area 491). Allocation of additional air blocks could occur at the same time to encompass the superadjacent airspace of that property, exclusive of the operation area. In this embodiment, the superadjacent airspace of property 447 undergoes division into two air blocks: A first air block encompasses the superadjacent air space overlying the majority of the circular operation area 491, and a second air block encompasses the air space over the property 447 outside of the operation area 491 Likewise, the airspace over the property 448 undergoes a split into two air blocks, the first encompassing a small portion over the operation area 491 and the second encompassing a larger portion of air space adjacent to the airport no-access zone 420. The superadjacent airspace over the road segment 406 undergoes a split into three air blocks: the first lying inside the operation area 491 and other two lying on opposite sides of the operation area 491. Splitting the air blocks in this fashion provides a mechanism by which an area of operation (e.g., the operation area 491) need not cut off access from one region to another: Even with a license granted for all of the available airspace within the operation area 491, the system 100 can automatically allocate air blocks available for license to provide access around what would otherwise have severed UAV access along the road segment 406.

Other techniques can also serve to maximize available air space. For example, an operation area larger than the operation 491 might encompass one or both of the no-access zones 420 and 430. In such a case, truncating or shrinking the operation area to exclude no-access zones can maximize available airspace. Second, placing further constraints on the operation area to leave a usable perimeter would increase the airspace and allow for licensable air blocks for navigation by other, unassociated UAVs. For example, a requirement could exist that an operation area maintains some separation (not shown) of a predetermined width (e.g., 20′) from a no-access region. Alternatively, a requirement could exist that an operation area exclude a particular stratum for licensing as an air block (or air blocks) to other UAVs.

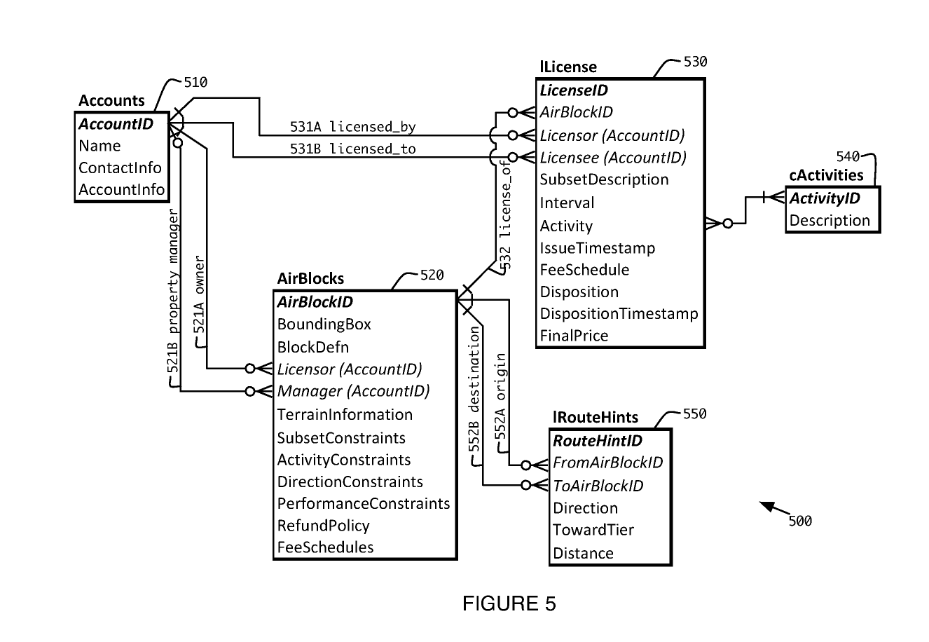

FIG. 5 shows one exemplary schema 500 for the air block database 132 of FIG. 1. The Schema 500 appears as a relational database for pedagogical reasons and not as a limitation. Generally, each account record listed in account table 510 in the Schema 510 corresponds to an air block owner 141. Each account has a unique identifier (e.g., AccountlD) and information about the corresponding air block owner 141, for example contact information and account information, which could include an account balance (not separately shown) or payment information (not separately shown) identifying the manner for handling payments made to the account.

As shown by an owner relationship 521A, each air block record has exactly one owning account in table 510, and each account might own zero, one, or more air block records. In this exemplary embodiment of air block table 520, each record corresponds to the entirety of the superadjacent airspace of a property (which can include road segments). Each air block record has a unique identifier (e.g., AirBlockID) and a description, shown here as including a bounding box (a rough description, suitable for quick, approximate calculations and navigational planning) and a block definition (a precise description, containing enough detail for navigation with the required accuracy). The air block record can include terrain information in the form of a topographic description detailing the ground surface (including the location of any bodies of water) and the location and height of obstacles such as trees, utility poles, power or communications lines, structures, landing stations, antennas, etc.

Each air block record can have associated constraints. In this embodiment, “subset constraints” describe the partitioning of the entirety of the superadjacent airspace into one or more air blocks. For example, the subset constraints could specify partitioning of the airspace into some number of strata of predetermined height (e.g., five 100′ strata, making five air blocks). For the airspace over a property with a tall building, there could exist a number of 100′ strata up to the height of the building, and another stratum perhaps 200′ tall used for landing or takeoff from atop the building, and additional 100′ strata above that up to 500′ above the top of the building.

With respect to the superadjacent airspace over a road segment, the default subset constraints can allow partitioning of the airspace into strata up to 500′. However, for roads less than 500 wide, the airspace managed by the system 100 could extend up to at least the height of an adjacent building, and 500′ above that height. As a matter of policy, or legislation, the system 100 of FIG. 1 could reserve the top-most stratum as a buffer between navigable airspace and licensable air blocks.

Subset constraints can also allow for partitioning of the airspace within a stratum (or in simple cases, in lieu of strata). For example, the airspace for the property 230 in FIG. 2 might include a subset constraint requires dividing the property into halves, one being a front portion (toward road segment 206) and another toward the back half of the property. In this way, a UAV, such as the UAV 101, could depart to deliver sugar to a neighbor along the flightpath 240, as described above, while simultaneously, another UAV could deliver a package to the front yard of the property 230, with each UAV having access to the property 230 with a corresponding license to a distinct subset of the superadjacent airspace.

The subset constraints of an air block record might require dividing an airspace (or stratum) into quadrants, and one or two adjacent quadrants might be simultaneously licensed. For example, the flightpath 240 in FIG. 2 appears only to cross property 234 at one tiny corner. In such a case, a UAV might only obtain a license for that quadrant of the property. With respect to shopping center 460, establishing subset constraints that divide the property into quadrants (or finer portions) would allow better access by the UAVs to that property. For example, the flightpath 480 associated with UAV delivery of a pizza would only require a license for the upper-right quadrant over the shopping center property 460. UAV deliveries to or from the department store 461 would require access only to the lower-right quadrant of the property 460. In contrast, UAV deliveries to or from the structures toward the far-back of the property 460, i.e., away from the road segments 405 and 403 and near highway no-access zone 430, can use the upper-left and lower-left quadrants licensed together to obtain access from road segment 405. Such UAV deliveries could also use the upper-left and upper-right quadrants of the property 460 licensed together to obtain access from road segment 403 (where this access occurs at a different time or employs different strata air blocks than the flightpath 480).

In situations where a transfer of a portion, but not all, of the superadjacent airspace to a different owner than the owner of the underlying land, a distinct air block record would exist in the table 520. As a result, one record can correspond to the original property owner with the retained portion of the superadjacent airspace described by the subset constraints, and a second record can correspond to the different owner, with transferred portion of the superadjacent airspace identified by subset constraints in the second record.

Direction constraints can also apply to the superadjacent airspace of the air block record overall, or may apply to each air block defined by the subset constraints individually. Effectively, direction constraints can turn an air block into what amounts to a one-way street. When applied to air blocks in different strata, particularly over a road segment, not only traffic flow, but navigational planning and license acquisition can occur more smoothly and efficiently. For example, the superadjacent airspace of road segment 203 is divided into two subsets at different strata, one directed generally north-westward (assuming north is toward the top of FIG. 2), and the other directed generally south-eastward, and assuming that adjacent road segments undergo division into similar, adjoining strata, then as soon as expiration or release of the license allowing a UAV headed north-westward over road segment 203 occur, another license becomes immediately available for another UAV headed in the same direction and needing access over road segment 203. This helps to minimize blockages, during which the system 100 of FIG. 1 will inhibit two UAVs in adjacent air blocks, headed in opposite directions until one or the other of them can get out of the other's way.

Direction constraints can also designate areas used by a UAV to climb or descend. Such constraints could serve, for instance, to designate a portion of a superadjacent airspace used by a UAV to make a delivery, for example, where vertical travel can occur over a patio, but otherwise, flight prohibitions exist in any direction in the bottom stratum from zero to 100′ in height. Such constraints would prohibit UAVs from changing strata over an intersection road segment (e.g., the road segment 202), as might be valuable for implementing a traffic engineer's strategy to emphasize straight-through traffic in busy intersections and relegating altitude changes in the air blocks for which less contention exists.

Activity constraints indicate the purposes associated with obtaining an air block license and/or to identify what purposes would preclude such a license. For example, an air block owner could allow or prohibit deliveries to or from a property. Further, an air block owner could allow or prohibit UAV aerial photography. In particular, an air block owner could differentiate between permitted and prohibited. For example, an air block owner could prohibit commercial photography, except for real estate photography associated with the sale of property by the air block owner or neighbors of that owner. Such constraints prevent “paparazzi” from flying over a property for photographing the property owner or his or her neighbors. Alternatively, if a property owner grants a license to its air blocks for “newsgathering” and a neighboring property wants to host a private event without intrusion by paparazzi UAVs, then that property owner could buy up all the air block licenses over the surrounding properties for the duration of the event, thereby acquiring a degree of privacy not otherwise available.

Performance constraints can also specify requirements that UAVs must meet when using an air block license. For example, given a physically narrow air block (e.g., an air block overlying a narrow road segment), a performance constraint can require the UAV possess a particular accuracy of lateral navigation, e.g., the UAV must have the capability of holding to a flightpath (or staying within an operation area) while not violating a predetermined distance from the sides of the air block (e.g., at least 10′), not counting a planned transition from one air block to the next. Generally a performance constraint would specify a different accuracy for vertical navigation, e.g., a predetermined distance of 20′ from the top and bottom of the stratum s adequate while not transitioning from an air block of one stratum to an air block of an adjacent stratum, or when taking off or landing. Lateral navigational accuracy may depend on precise Global Positioning System (GPS) data, or on maintaining an optical detection the ground track of the UAV over a street, or using navigational (i.e., fiducial) markers located in certain street lighting standards or other infrastructural locations, or other kind of navigational techniques. A performance constraint could require that a UAV have certain kinds of navigational capability. For example, a performance constraint could require a UAV to possess some kind of non-GPS-based navigational capability within air blocks known to have bad GPS interference, as in metropolitan areas where tall buildings block, reflect, or otherwise adversely affect GPS satellite signals. In some cases, performance constraints could require a UAV to sustain a minimum airspeed, thus allowing designation of certain air blocks for high speed travel, which also limits the amount of time required for an air block might having such a speed requirement.

Over time, as UAV technology improves and UAV performance increases, designated levels of performance will become more common and air blocks with such designations enable better utilization of airspace as a resource. Performance constraints, along with subset and direction constraints, provide a mechanism for making simple and incremental changes to airspace management that allow for greater, more effective utilization in the future as the UAV capabilities improve.

Each air block record has a fee schedule that could include different air block license rates based on subset constraints and/or activity constraints. Fee schedules identify the cost paid by an air block licensee to the licensor (e.g., the owner) of that air block. Such fee schedules allow the UAV manager 120 to compare costs of different routes (i.e., flight paths) associated with a particular UAV activity. The Air Block License Server (the ABLS) 130 will typically maintain a transaction policy (not shown) to indicate whether an air block licensee needs prepay for an air block license and how soon before the license interval a licensee must cancel the license qualify for a refund, the cancellation fee, if any, the form of the refund and payment interval as well as other business policies.

In some embodiments, the licensor (e.g., property owner) associated with an air block record in table 520, as identified by the owner relationship 521A, may designate a manger for the air block record, as identified by property manager relationship 521B. Such a designation by the owner permits the manager to perform certain functions (which could be explicitly designated, not shown). For example, if constraints for an air block license do not currently exist, the licensor could authorize the manager to define subset constraints for the superadjacent airspace associated with the air block record. Additionally, the manager could possess the authorization to change existing subset constraints. For example, the manager could change the direction and performance constraints to designate air blocks that are more useful, more efficient, and more effective, given that a manager likely has a greater degree of expertise in the UAV flight management as compared to a typical owner. Also, the managers typically control the air block records for many adjacent properties, allowing a greater degree of coordination among them. For example, a single manager (or management team) could have the responsibility of managing all of the air block records corresponding to a municipality's road segments. Even where different managers of a team have responsibility for separate air blocks on opposite sides of a border between two road segments maintained by different entities, the managers on such a team would have the expertise and responsibility to coordinate such junctures well.

Table 550 of FIG. 5 depicts a linking table, noting associations that provide routing hints from one air block record in table 520 to one or more other air block records in table 520. The route hint records make it easier for route-generating software, as might reside in either or both of the UAV manager 120 and/or the air block license manager 130. In the exemplary embodiment shown, each route hint record identifies the air block record from which the hinted route proceeds and designates the origin relationship 522A. The hint record also identifies the air block record to which the hinted route proceeds and designates the destination relationship 522B. Such hints can provide adjacency information. For example, such route hints could that indicate that the property 230 of FIG. 2 lies adjacent to the road segment 206, and that the road segment 202 lies adjacent to road segments 201, 203, and 208, in a computationally more efficient manner than searching by latitude/longitude (as might be used for the bounding box or block definition of an air block record). Other details recorded here that can help in route planning could include the direction to which the route hint corresponds when traveling from the origin air block to the destination air block. As an example, given a local navigational goal of traveling generally northward when in an air block that corresponds to the road segment 202, the original relationship 522A indicates a relationship among several route hint records, making a selection among the several records easier when a direction field for one (or more) of those several route hint records indicates a direction corresponding to generally northward. This circumstance might occur for a route hint record identifying a destination relationship 522B the air block record corresponding to road segment 201 (which runs generally northward from road segment 202 in FIG. 2).

Route discovery algorithms for automobiles and trucks can prove useful for managing the UAV flight paths. In this regard, some route discovery algorithms for automobiles and trucks divide road maps into segments, each segment lying between two intersections. Besides direction, such algorithms describe segments as located in, or headed toward, tiers. In this context, tiers relate to a minimum expected useful distance as a navigational goal. Interstate highways comprise first tier segments, that is, major traffic arteries remain most useful when covering major distances for a navigational goal, assuming that that the interstate highway segments head generally in the desired direction of travel. However, interstate highway travel becomes disadvantageous when the distance between the present position and the navigation goal remains relatively short since traveling to the interstate highway typically results in overshooting the navigational goal unless travel on the interstate constitutes the goal. Lower tiers correspond to lesser arteries, e.g., highways, boulevards, streets, avenues, down to the lowest tiers (which identify dead-ends and cul-de-sacs, since they cannot represent a route to anywhere other than to those addresses on that segment).

In such usage, a route hint record can indicate that a particular destination air block record represents a path toward a tier (or tiers, not shown) and can also provide the distance to such a tier. For the UAV flightpath planning as might be conducted for example by the UAV manager 120, having the UAVs navigate through mountain passes can result in greater efficiency, rather than have the UAVs climb over mountain peaks, even if the later achieves a shorter overall, if not merely ground, distance. In such circumstances, air blocks through such passes would represent “top tier” segments. However, unlike a road map-based navigation plan, properties such as property 230 do not necessarily represent a “bottom tier” in the sense of a dead end (that is, after property entry, no other exit exists.) A flight path through the property remains possible, for example, the flightpath 240 routes from the property 230 through the property 231 and the flightpath 241 routes through road segment 206: The Property 230 does not constitute a dead end to the UAV navigation, at least not necessarily.

However, constraints imposed on neighboring airspace can effectively render the property 230 as a dead end. Suppose that the property 230 does not prohibit overflight by the UAVs performing deliveries to other properties, but that all of the neighboring properties do prohibit such access for individual properties. In that case, a routing algorithm working from road segment 206 will consider property 230 to constitute dead end (for the activity of delivery to properties other than the property 230). Such a determination can occur in advance and be noted in the corresponding route hint record with the origin constituting the road segment 206 and the destination being the property 230. While such routing hints need not identify candidate flightpaths in accordance with the present principles, such hints can improve performance in some circumstances.

The License table 530 comprises license records that identify the air blocks now licensed as well as the licensees of such air blocks. Each licensed air block is specified by a combination (in this exemplary embodiment) of the air block record designated by license-of relationship 532 and the subset description in the license record. The license applies to the subset(s) of the superadjacent airspace identified by the subset description field, where the subset constraints associated with the corresponding air block record define possible air block choices. The licensor field identifies the air block owner at the time the of the license grant, as noted by licensed-by relationship 531A. In rare circumstances, the licensor in the license record could differ from the current owner relationship 521A for the same air block record, if the ownership has changed since granting of the license. The licensee field identifies the account of the entity that received the license. In this embodiment, the records in the account table 510 include records for both the air block owners (i.e., licensors) and air block licensees but other embodiments might represent these roles using distinct record types (not shown). The interval field in each record indicates the time period during which the license remains valid, typically represented as a starting date and time, and either the license duration or an ending date and time. The activity field indicates the activity or activities permitted for this license. A more elaborate description of such activities appears in the activity types table 540. The license record can also include a timestamp to indicate the date and time of license issuance and the applicable fee schedule applied at the time of license grant.

The disposition of a license can include cancellation, for example by a licensor, licensee, or external authority (as in an emergency, when a governmental entity might commandeer or otherwise close certain airspace.) Such license disposition can also include an indication of “used as issued” (i.e., for the entirety of the license interval as stated); or used and released (i.e., a notification that use has concluded before the interval has expired). In some embodiments, the license disposition could note a violation of the license, e.g., the licensee's the UAV did not vacate air block until after expiration of the license. In such cases, the fee schedule or policies imposed by the air block licensing entity could impose a penalty for overrunning the license interval. The license record will typically record a final price based on the fee schedule and the disposition (e.g., penalty, if any) for payment from the account of the licensee to the account of the licensor.

FIGS. 6-8 illustrate a range of example transactions associated with air block management in accordance with the present principles. FIG. 6 illustrates an exemplary transaction sequence 600, wherein a UAV operator 111 exercises real-time control of the activity of the UAV 101 (both of FIG. 1). In preparation for instantaneous control interactions, the UAV operator 111 (through the UAV operator terminal 110) sends an activity request 611 to the UAVMS 121 of the UAV manager 120. The activity request identifies the nature of the planned activity and indicates a desired operating interval. For example, the planned activity could include newsgathering at a particular location (e.g., the operation area 491 of FIG. 4) to occur during an interval to begin immediately (or as soon as achievable) and to last for up to an hour. Accordingly, the activity request 611 could specify a desired operation area, (e.g. the operation area 491) and an hour-long desired interval of operation to begin immediately.

In one embodiment, the activity request 611 can be absolute, that is, the UAV manager 120 of the system 100 of FIG. can either fulfill that request as stated, or fulfillment fails: No partial fulfillment can occur. In another embodiment, the activity request could include flexible terms by a default amount. For example, the UAV manager 120 could fulfill a request with a desired interval starting “now” with a response that provides an interval of operation starting anytime within ten minutes or so. Also, the UAV manager 120 of FIG. 1 could satisfy a request with desired interval duration of an hour might with a response with an interval of at least 50% that duration. In still another embodiment, the activity request can include an acceptable range for each value: The request can designate the entire the operation area 491, but that the licensee would accept any 70% of that area. Similarly, the request could specify a license for an hour, to begin now, but could indicate that the licensee would accept any start time with twenty minutes and a duration lasting at least twenty minutes.

Additionally, an activity request 611 could designate a price limitation for the desired area and interval of operation, or could designate a limit on the rate for the activity (that is, a price for a particular interval). In popular areas of operation, or during intervals of high contention, the price-per-minute for an air block license might exceed that for nearby, but less popular areas, or for other times when requested intervals become fewer or of shorter duration. A request with a price limitation states, “Do not pay more than $x for the activity requested,” while one with a rate limitation means, “Do not pay more than $x per minute for the activity requested.” The system 100 can fulfill the former request with an interval cut short (if acceptable), so as to keep the price from exceeding the limitation. The latter request provides that the rate limitation should not exceed the specified rate when fulfilled, but fulfillment could be the full interval requested, or less, with the actual price varying with the interval offered. Similarly, the UAV manager 120 of FIG, 1 could meet price and or rate limitations by limiting the air blocks licensed—e.g., providing licenses that cover less of the requested operation area or providing licenses to air blocks available without the limitation.

In turn, after receiving the activity request 611, the UAV manager 120 generates one or more air block license requests 613, apropos to the activity request 611, and makes the request to the ABLS 131 of FIG. 1 of air block license manager 130 of FIG. 1. Depending on the embodiment, the UAVMS 121 could make a single block request which the ABLS 131 makes a best effort to fulfill, or the ABLS 131 may fulfill only explicit requests, and refuse others. In the former context, an air block license reply may comprise one or more licenses that fulfill all or a portion of the corresponding request, e.g., a license for an interval later than and/or shorter than requested, without exceeding a stated price limitation (if any). In turn, the UAVMS 121 will accept or reject the license(s) so offered. In the latter context, the ABLS 131 will grant the license as requested without exceeding any stated price limitation, or will deny the request. Upon denial of the request, the UAVMS 121 will need to modify and/or resubmit the request in order to obtain a suitable license.

The exact transaction occurring after an air block license request 613 can vary, depending upon implementation. The corresponding offered air block license reply 614 could contain a responsive license, or a denial. If the ABLS 131 offers a license in the air block license reply 614, the system 100 can implement a policy that presumes granting of a license and acceptance by the licensee, which is best limited to cases where the air block license reply 614 offers air block licenses that completely satisfy the corresponding air block license request 613. Alternatively, the UAVMS 121 can evaluate the license offer and send a subsequent commit license message 617 back to the ABLS 131 explicitly accepting or rejecting the proposal carried in the air block license reply 614. In still another embodiment, the subsequent commit license message 617 can indicate a selection of one or more alternative licenses proposed in offered air block license reply 614. In other words, the UAVMS 121 of FIG. 1 can accept the license with the best fit offered by the ABLS 131. Regardless of the details of the implementation of the transactions, the following premise remains, a licensee can seek one or more air block licenses in the request 613, and the UAVMS can offer one or more air block licenses in the reply 614.

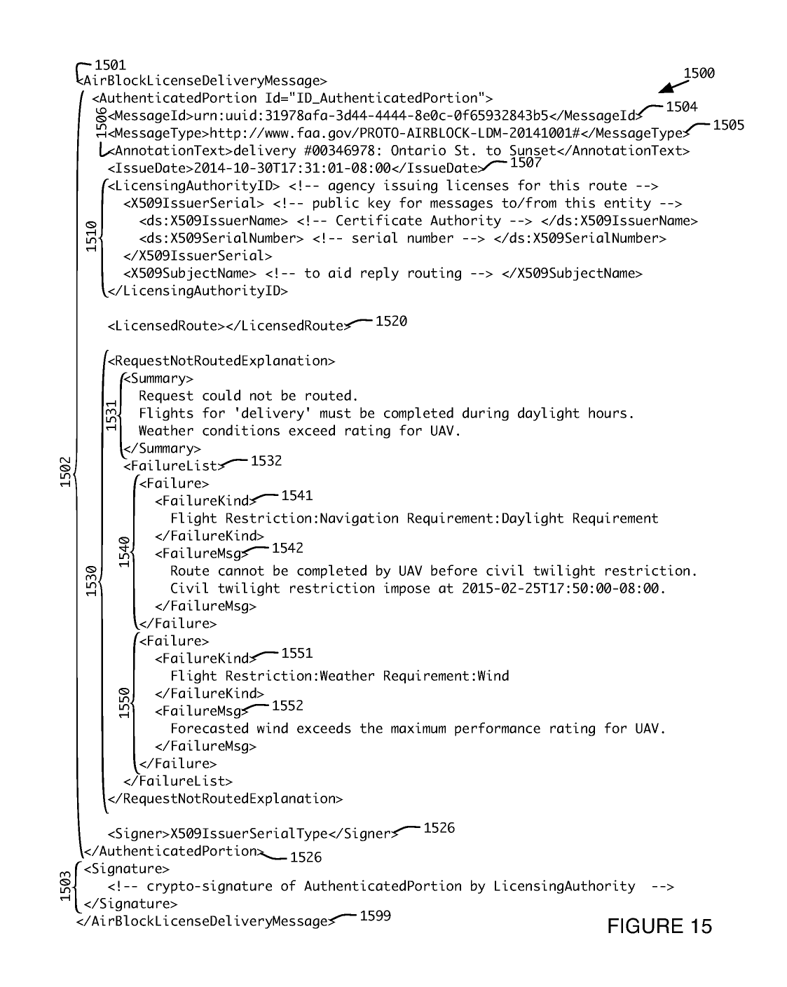

After the UAVMS 121 has obtained a sufficient number of adequate license offers for the activity request 611, the UAVMS 121 can return a route reply 615. In the example discussed above regarding newsgathering in the operation area 491 of FIG. 4, the route reply 615 would comprise one or more licenses for air blocks associated with at least some of the properties 447, 448 and the road segment 406 of FIG. 4. In embodiments where replies such as the reply 615 are always complete, acceptance of the offered licenses representing the route can in the form of a accept route transaction 616 can occur automatically since the UAV operator 111 obtained everything requested in the message 611. However, in embodiments where a route reply 615 does not permit the full area or interval of operations as requested, or exceeds a cost constraint, an operator 111 can have the ability to reject the licenses offered in the route reply 615 (rejection transaction not shown). Further, in embodiments in which the UAV operator 111 does not constrain the price for activity request 611, UAV operator 111 may reject (not shown) the licenses offered in the route reply 615 if the price exceeds a threshold value. If the accept route transaction 616 requires explicit acceptance, the UAVMS 121 could require such acceptance occur before an expiration time. This requirement avoids the UAVMS 121 waiting an indefinite period for an accept route message 616, since that could allow the offered licenses to remain committed until the licenses themselves have expired, with the result of having produced no value for the airspace owner. Accordingly, the UAVMS 121 could establish a policy that the offer of licenses proposed in a route reply 615 expires if not accepted with an accept route message 616 within a predetermined amount time (e.g., 5 or 10 minutes for example), or by a time specified in the route reply. Alternatively, the policy can specify default acceptance of the licenses offered in a route reply 615 unless declined within a predetermined amount of time, or by a time specified in the route reply. In some cases where the activity request 611 does not permit fulfillment (not shown), a route reply can indicate a routing failure or denial (discussed in detail below in conjunction with FIG. 15), and a new, perhaps reformulated route depending on the cause.

Upon acceptance of a license or licenses via accept route message 616, the UAVMS 121 can commit the licenses with a commit license message 617 (if not otherwise already committed, depending on the transaction policy). The UAVMS 121 records the actual licenses in license table 530 of FIG. 5 in the air block database 132 of FIG. 1 as issued by setting the issue timestamp, so that issuance of conflicting air block licenses cannot occur. Even while when an air block license remains pending after being proposed in a route reply 615, but before being accepted by accept route message 616, the UAVMS server 121 can record the license in table the 530, for example with a disposition of “pending” and a timestamp representing a time at which the offer will automatically expire, unless accepted before then.

In some embodiments (not shown), the UAVMS 121 could maintain a waiting list for air block requests that would otherwise conflict, and upon expiration a pending air block license or upon being declined, the UAVMS server can handle the next request on the waiting list, either in the order queued, or perhaps according to a prioritization other than first-in, first-out queuing, which might be, for example, to give priority to a highest bidder.

In still another embodiment, the ABLS 131 could offer conflicting air block licenses and only a first acceptance, as triggered by the accept route message 616 to the UAVMS 121 followed by the commit license message 617 to the ABLS 131, will succeed and actually result in delivery of the offered license. The UAVMS 121 will then cancel conflicting licenses offered to others (e.g., other operators or other UAVs) and any later arriving acceptance (not shown, but like another accept route message 616 from a different source) will fail and not provide the previously offered license.

Different policies can exist for license requests having different time frames. If the activity request 611 specifies an interval starting several days from now, there is less need to offer licenses that conflict, and less need to expire any offers of licenses in a short amount of time. However, if the activity request 611 requires is for immediate use (as may occur for a “breaking” news story, or an ad hoc UAV flight starting now), then offering licenses on a “first-to-accept” basis or a “this offer expires in 10 seconds” or other short expiration time limit basis more appropriate. The UAVMS 121 can place a limit on how frequently the UAV 101 or the UAV operator 111 can place air block requests.

Upon acceptance of the route, the UAVMS 121 of FIG. 1 transfers the corresponding license to the UAV operator console 110 of FIG. 1 (represented by the UAV operator 111 in FIG. 6), in a permissions message 618. The UAVMS 121 can receive the originally offered licenses or the ABLS 131 can at least describe them in the offered air block license reply message 614 with only the accepted licenses being retained and used. The UAVMS 121 sends the licenses (or at least describes them) to the UAV operator console 110 in the route reply message 615 and again, with only the accepted licenses being transferred (whether in the route reply message 615 or in the permissions message 618) for being retained. Referring to the license table 530 in FIG. 5, a description of the license does not require the whole license record from table 530. For example, in some circumstances, such as in connection with license evaluation or in connection with establishing the UAV flight restrictions, information such as the subset description, interval, activity, and/or fee schedule can suffice. If the subset description does not already comprise the block definition from the corresponding air block record in table 520 via license-of relationship 532, then the block definition also may become necessary.

In other embodiments, the offered air block license reply 614 might only contain some information about a proposed license, for example a block definition and price schedule. In such an embodiment, the UAVMS 121 could rely on the ABLS 131 to limit proposals to licenses (and air blocks) that meet the constraints provided. Similarly, the information returned in a route reply 615 to the UAV operator terminal 110 or UAV operator 111 could entail a similar description or be further reduced, e.g., to one or more proposed flightpaths or operation areas (which might be approximated) and an aggregated price for the requested activity. In an embodiment such as this, the permissions message 618 could contain greater detail. In a related embodiment, a permission message (not shown) from air block license manager 130, similar to the permissions message 618, could undergo transmission to the UAV operator terminal 110 directly. Authentication of Permissions messages such as permission message 618 can occur to ensure that tampering licenses or license descriptions has not occurred.

In the example transaction sequence of FIG. 6, the UAV operator 111 (operating through the UAV operator terminal 110) typically exercises relatively direct control over the UAV 101. The UAV operator 111 exercises such control by sending an activity command 630 to the UAV 101, and the UAV complies. The UAV 101 provides status report 631 periodically, or upon an event. In some cases, upon receiving a status report 631, which might indicate for instance that the UAV 101 has exited a particular air block, the UAV operator terminal 110 might determine that subsequent activities do not require further use of that air block. When a progress report 632 to the UAVMS 121 indicates that use of that air block has concluded, block the UAVMS 121 can send a release message 633 to the ABLS 131 to indicate that use of the licensed block has concluded and that the ABLS can close the license, allowing release of the air block for licensing to others.

In some embodiments, not shown, the above-described interaction can occur progressively. The UAVMS 121 could acquire a few air block licenses from the ABLS 131 and provide them to the UAV operator 111 for use with the UAV 101. As the UAV 101 provides status reports indicating progress that allows release of earlier granted air block licenses, the UAVMS 121 can acquire further air block licenses (not shown), keeping ahead of the progress of the UAV 101, but without tying up the whole set of licenses needed for the entire interval of operation. This is particularly valuable if the transit time of UAV through an area is uncertain, or if there is a lot of contention for the air block licenses a “waiting” interval may become a necessary to gain access to certain of the air blocks.

In some circumstances, a status report 641 may indicate a position or activity of the UAV 101 that deviates from the terms of the acquired license. Perhaps an overpowering gust of wind has caused the UAV 101 to drift into an air block for which the UAV has not obtained the requisite air block license or a headwind has sufficiently delayed the progress of the UAV 101 so that the interval for the air block license currently occupied the UAV expired before the UAV could exit the air block. In such a case, the UAV operator terminal 110 can issue a violation report 642 to the UAVMS 121 to log the incident for separate handling.

Eventually, the UAV operator 111 signals the UAV 101 with a done command 650, which could follow by landing of the UAV 101 or in the alternative, initiate an automatic landing of the UAV 101. Upon concluding its operation, the UAV 101 provides a completion report 660 to the UAV operation terminal 110. The UAV operator terminal then provides an activity complete message 670 to the UAVMS 121, which in turn releases any remaining air block licenses for the activity request 611 with an air block release message 671 to the ABLS 131.

Thus, in the exemplary transaction sequence 600 of FIG. 6, the UAV operator 111 will generally directly control, perhaps manually control the UAV 101, or manually control the UAV as mediated or augmented by the UAV operator terminal 110. The UAVMS 121 first requests anticipated activities and then negotiates with the ABLS 131 until an adequate and satisfactory air block license or licenses become available and thereafter accepted. Manual control of the UAV 101 proceeds, with the UAVMS 121 releasing air block licenses when possible, and logging violations when unavoidable. In the scenario of the transaction sequence 600, the UAV operator 111 has the responsibility for keeping the UAV 101 within the bounds of the licensed air block(s). The UAV 101 lacks awareness of the licenses, and does not constrain its operation and activities to stay within the limits of the acquired license(s). If the UAV travel involves a route, e.g., pizza delivery flightpath 480 from FIG. 4, in lieu of an operation area (e.g., operation area 491), then the UAV operator 111, in combination with the UAV operator terminal 110, controls travel along flightpath 480. For example, the UAV operator 111 could control the UAV 101 while standing stands on the roof of the pizza restaurant 462 of FIG. 4 to visually the observe the UAV flight. More likely, the UAV operator 111 will control the UAV 101 while monitoring its progress through sensors on the UAV itself (e.g., an on-board pilot's view camera or cameras).

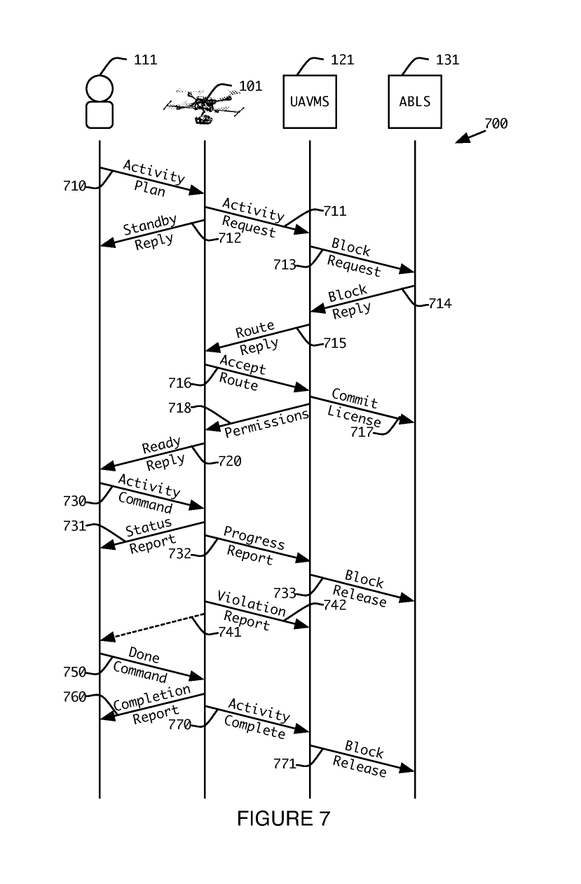

In stark contrast to manual control of the UAV 101 in conjunction with the transaction sequence 600 of FIG. 6, FIG. 7 illustrates an alternative significantly autonomous transaction sequence 700. The transaction sequence 700 commences with the UAV operator 111 issues an activity plan 710 to the UAV 101 using the UAV operator terminal 110. In response, the UAV 101 communicates an activity request 711 to the UAVMS 121, while replying to the UAV operator terminal 110 with a standby reply 712, to indicate receipt and processing of the activity plan 710.

As with the transaction sequence 600, during which the UAVMS 121 accepts the activity request 611, during the transaction sequence 700, the UAVMS server accepts an activity request 711. In response, the UAVMS server 121 generates an air block request 713 for transmission to the ABLS 131, similar to the air block request 613 of FIG. 6. The ABLS 131 returns an offered air block license reply message 714 to the UAVMS 121, similar to the offered air block license reply message 614 of FIG. 6. The UAVMS 121 then returns to the UAV 101 a route reply 715, based on the offered air block reply (or replies) 714 as the response to the activity request 711. When accepted with an accept route message 716, the UAV 101 commits to the licenses by a message 717 and the UAVMS 121 relays a permissions message 718 to the UAV 101 providing detailed and authenticated license information. In some embodiments (shown in FIG. 7), the UAV 101 sends ready reply 720 as a response to activity plan 710. The UAV operator 111 can issue the activity command 730, directing the UAV 101 to engage the plan. In other embodiments, the UAV 101 could immediately begin operation (not shown) upon receipt of the permissions message 718.

Upon activating the plan, the UAV 101 sends a status report message 731 periodically and/or whenever pertinent events occur. Progress report messages from the UAV 101 to the UAVMS 121 can indicate that portions of the flight plan completed, allowing the UAVMS 121 to issue on more block release messages 733 to the ABLS 131 to close out an air block license and allow granting of a license to the block license to other entities. An air block violation, as discussed above, constitutes an event detected and reported by the UAV 101 to the UAVMS 121 with a violation report 742, which could trigger a status report 741 back to the UAV operator 111. Upon completion of a planned activity or the UAV operator 111 has issued a done command 750, the UAV 101 will cease flight operations. The UAV 101 then issues to the UAV operator 111 a completion report 760 summarizing the activity now concluded. The UAV 101 will also issue an activity complete message 770 to the UAVMS 121. In response, the UAVMS 131 will send a block release message 771 to the ABLS 131 to close out any remaining licenses to air blocks acquired for the activity plan 710.

Thus, during the transaction sequence 700, the UAV 101 operates largely autonomously, sending the status reports 731 and 741 for oversight by the UAV operator 111. Such an operating mode of operation has particular value for operations based on an activity plan, particularly as resolved by routing a flightpath, e.g., flightpaths 240 and 241 in FIGS. 2 and 3, respectively, and flightpath 480 in FIG. 4, navigated by the UAV 101 autonomously, or mostly autonomously. Thus, for the most part, the UAV operator 111 need not intervene in the operation of the UAV 101, though perhaps takeoff or landing might require assistance or at least careful monitoring by the UAV operator. In this embodiment, the UAV 101 knows the route, carries the permissions, and reports violations directly to the UAVMS 121. As such, this transaction sequence has particular suitability for delivery services, or for conducting a patterned photographic survey of an area.

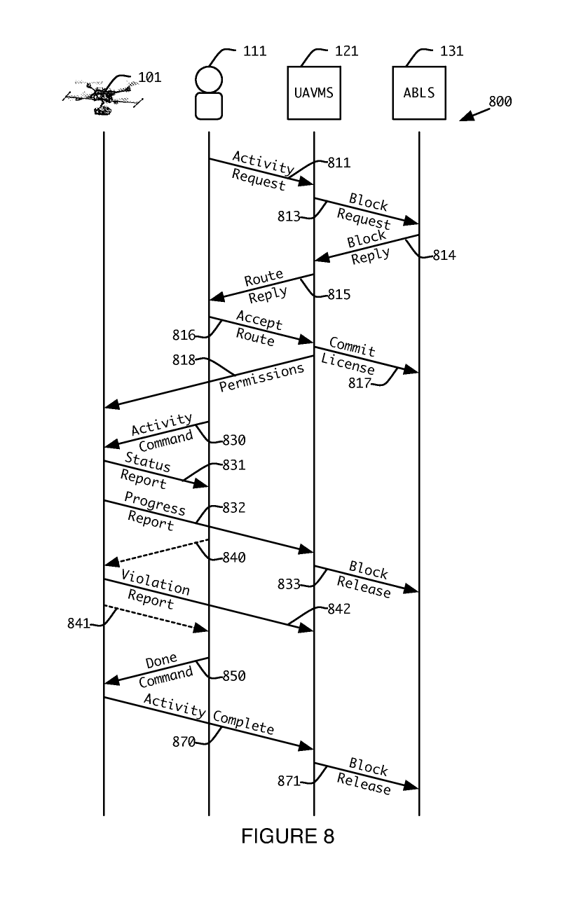

FIG. 8 depicts a hybrid approach transaction sequence 800, where the UAV operator 111 submits an activity request 811 to the UAVMS 121. In response, the UAVMS 121 issues a block request message 813 to the ABLS 131, which responds with an offered air block license reply message 814. The UAVMS 121 proposes a route reply 815 to the UAV operator 111, who accepts with an accept route message 816 (if required) sent to the UAVMS 121. The UAVMS 121 then issues a commit license message 817 (if required) to the ABLS 131, and sends a permissions message 818, comprising the authenticated license information, directly to the UAV 101, or indirectly (not shown) through the UAV operator terminal 110 to the UAV 101. The UAV operator 111 issues activity commands 830 and 840 to the UAV 101, and the UAV 101 complies with within the limits of the license information in the permissions 818. The UAV 101 sends status reports 831 and 841 periodically, or upon an event, to the UAV operator 111. The UAV 101 also sends progress reports 832 to the UAVMS 121 to indicate when the UAV has cleared an air block to allow the UAVMS 121 to send a block release message 833 to the ABLS 131 to close out the corresponding air block license to allow grant of a license for that air block to another entity.

If the UAV 101 detects a violation of the issued licenses, it provides a violation report 842 to the UAVMS 121. When the activity is complete, the UAV operator 111 issues a done command 850 to the UAV 101, in response to which the UAV 101 issues activity complete message 870 to the UAVMS 121 and the UAVMS 121, in turn, issues block release message 871 to the ABLS 131 to release any remaining air block licenses.

The transaction sequence 800 has particular applicability for newsgathering or aerial photography (e.g., for movies or real estate purposes), where the UAV operator 111 is primarily concerned with real time, ad hoc operation, e.g., to get a particular photographic shot of a planned event (e.g. a movie scene) or a dynamically unfolding event (e.g., a newsworthy event). Alternatively, the UAV operator 111 may need to fly the UAV 101 to a good vantage point, where the “vantage point” is defined by a view from a UAV-born camera, rather than from a navigational reference. This configuration possesses the advantage that while the UAV operator 111 manages these concerns, the UAV 101 possesses the needed air block licenses and can constrain its flight and activities to air blocks for which it holds licenses. The UAV 101 reports violations; however they may occur, to the UAV operator 111. In this way, the UAV operator 111 can acquire real-time UAV control, but the UAV 101 uses its own navigational capabilities to determine compliance with agreed upon limits.

The transaction sequence 600 above remains well suited when the activity request 611 includes a request for a plurality of the UAVs 101 to operate simultaneously under an single air block license, for example to shoot a movie or cover a sporting event with multiple UAVs. In some embodiments supporting such a scenario, the activity requests 611 and 811 or the activity plan 710 would indicate that the same licensee has authorization for multiple UAVs (corresponding to licensed-to relationship 531B in FIG. 5). In some cases (particularly, the hybrid transaction process 800), an activity request can explicitly list the identity of each authorized UAV. Note that the ABLS 131 could preclude multiple UAVs as could the activity constraints associated with the requested air blocks that limit the number of the UAVs simultaneously allowed to access the same air block. In the absence of such preclusions, the block reply 614 should indicate that the license authorizes the UAV operator 111 to operate a number of the UAVs in the licensed air block simultaneously. Multiple UAV operator terminals 110 (not shown) can share this license information as permissions a message 618 (or copies thereof shared with other terminals 110). Accordingly, each the UAV operator terminal 110 will constrain it's associated the UAV 101 (or the UAVs) according to the air block license obtained or, in other embodiments, shared with the UAVs 101 themselves through permissions messages 718 and 818. In embodiments where the activity request 811 includes a list of the authorized UAVs, the corresponding permissions message 818 may likewise contain a list of authorized the UAVs, with the same message provided to each of the authorized the UAVs, or a separate authorization message provided to each the UAV. In circumstances where multiple the UAVs have permission to operate simultaneously in the same air block, the UAV operator(s) 111 have the responsibility to avoid collisions and other mutual interference, or at least some of the UAVs must possess collision avoidance capabilities, e.g., sensors able to detect and maintain a minimum distance from other the UAVs. In embodiments where the UAVs 101 have the responsibility for mutual collision avoidance, the UAV manager 120 can make a determination that the group of the UAVs intended to operate under a requested air block license possess adequate mutual avoidance capabilities, e.g., that of the N the UAVs listed in the request, at least N-−1 of them possess autonomous avoidance capabilities sufficiently adequate to ensure that collisions do not occur. In other embodiments, a single the UAV operator terminal 110 might control the plurality of the UAVs within the licensed air block, and ensure that they maintain at least the appropriate minimum mutual spacing.

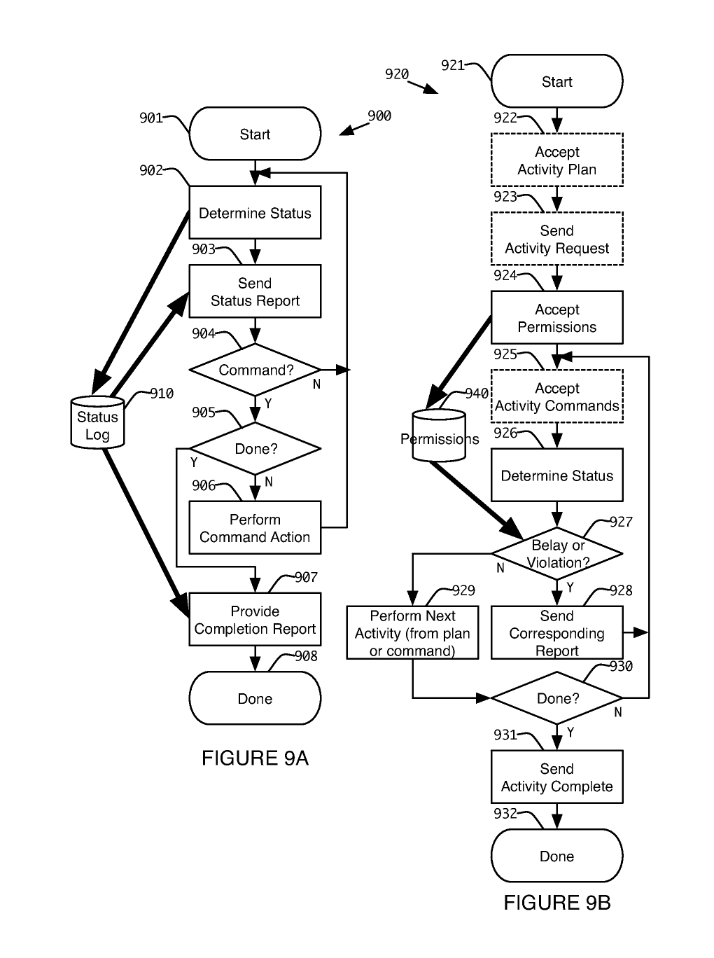

FIGS. 9A and 9B depict flowcharts indicative of the steps associated with the flight processes 900 and 920, respectively, for manual and autonomous (or semi-autonomous) operations, respectively, performed by the UAV 101. The manual flight process 900, suitable for use with the transaction sequence 600 of FIG. 6, begins during step 901 at which time the UAV 101 determines its readiness for flight while in communication with the UAV operator terminal 110. During step 902, the UAV 101 determines its status, comprising for example navigational information (e.g., position, heading, ground speed, wind speed, attitude), sensor information (e.g., cameras, hazard detection, range sensors), battery condition, power consumption, and other such information appropriate to piloting the UAV 101, which may be recorded in the status log 910. During step 903, the UAV 101 reports its status the UAV operator terminal 110, typically by recalling such information from the status log 910.

During step 904, if the UAV 101 receives no command from the UAV operator terminal 110, the process 900 continues back during step 902. However, if the UAV 101 receives a command, the process advantageously proceeds to step 905 during which here a check occurs to determine if the UAV 101 received a “done” command. If not, then during step 906, the UAV 101 performs the commanded action and the process 900 continues back to step 902. If, during step 905, the UAV 101 receives a “done” command, then during step 907, the UAV provides a completion report to the UAV operator terminal 110, based on the status log 910. During step 908 the manual flight process 900 concludes.

The UAV 101 performs the flight process 920 when operating in an autonomous mode compatible with transaction process 700 of FIG. 7, or in a hybrid, semi-autonomous mode compatible with transaction process 800 of FIG. 8. Each mode uses a different set of dotted-line steps 922, 923, and 925, as described below. Flight process 920 begins during step 921 whereupon the UAV 101 determines its readiness for flight while in communication with both the UAV operator terminal 110 and the UAVMS 121. While operating in an autonomous mode, the UAV 101 accepts an activity plan 710 from the UAV operator 111 during step 922 and thereafter, in step 923, sends an activity request 711 to the UAVMS 121. In either mode, the UAV 101 receives air block license information in a permission message 718 and 818 from the UAVMS 121 (whether directly or indirectly through the UAV operator console 110). The UAV 101 accepts such licenses by accepting the permission message during in step 924 and stores the permissions in a permissions memory 940. While operating in a semi-autonomous mode, the UAV 101 will accept an activity command, e.g., activity command 830, during step 925, even though in an autonomous mode, the UAV might accept some activity commands, e.g., activity command 730.

During step 926, the UAV 101 determines its own status. Following step 926, the process 920 includes an operating loop that commences with step 927, during which the UAV 101 determines whether a violation has occurred or will occur, based on a comparison of the status and the air block license information in the permissions memory 940 and whether the UAV must interrupt or belay an activity to prevent or limit the violation. If so, the UAV 101 generates a corresponding report 742 during step 928 and the loop returns to step 925, otherwise, the UAV initiates or continues the activity during step 929. During step 930, the UAV 101 determines whether the activity plan from step 922 had completed, and if not, the loop returns back to step 925. Otherwise, the UAV 101 sends an activity complete message 770/870 to the UAVMS 121 during step 931 and the flight process 920 concludes during step 932.

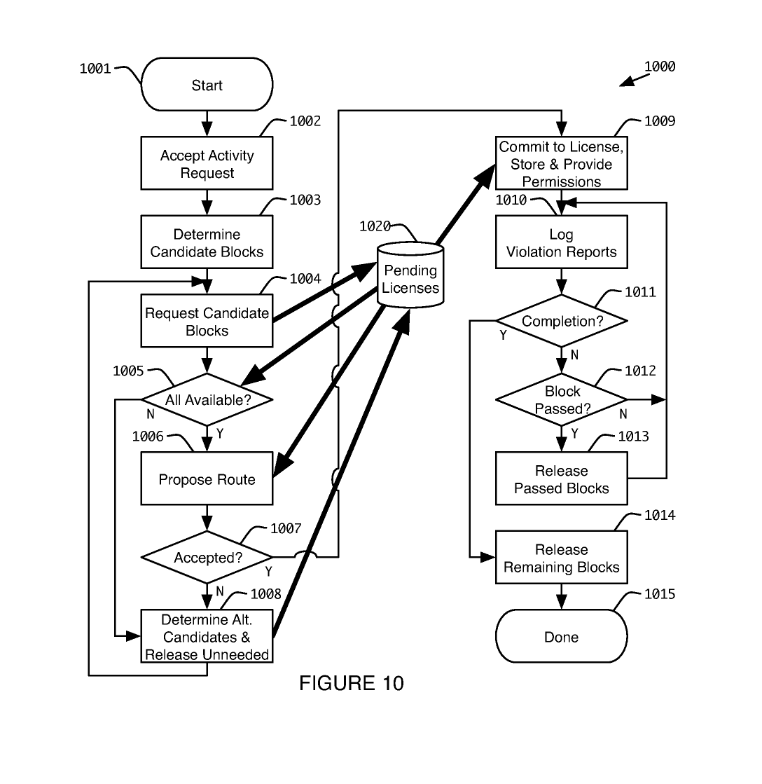

FIG. 10 depicts a UAV management process 1000, performed by the UAV manager 120 of FIG. 1. The UAV management process 1000 begins at start step 1001. During step 1001, the UAV manager 120 communicates with the air block license manager 130, and either the UAV operator terminal 110 (as described in FIG. 6), the UAV 101 (as described in FIG. 7), or both (as in FIG. 8), depending on the kind of transaction sequence used (the manual sequence 600, the autonomous sequence 700, or the semi-autonomous 800 sequence, respectively.) During step 1002, the UAV operator 111 or the UAV 101 receives one of an activity request 611, 711, or 811. During step 1003, the UAV manager 120 determines a candidate route and corresponding candidate air blocks based on the activity request and information from the map database 122 of FIG. 1. For example, given an activity request 611 for a newsgathering activity to occur in the operation area 491 of FIG. 4, the UAV management server 121 can query map database 122 to determine that the properties 447 and 448, and road segment 406 lie within the requested operation area 491.

In some embodiments, the activity request 611 can specify a minimum required range of altitudes for newsgathering. Alternatively, a predetermined default range of altitudes for an activity may apply when not otherwise specified. For example, during newsgathering in the operation region 491 of FIG. 4, the UAV 101 would likely take off and land from a news van (not shown) parked along the road segment 406. Under such circumstances, the minimum required altitude for an air block corresponding to road segment 406 would need to extend down to the ground to accommodate takeoff and landing, whereas over the properties 447 and 448, the minimum required altitude could be higher, e.g., 100 feet, since takeoff and landing likely will not occur there. In the case of a route needed from point A to point B, e.g., from the pizza restaurant 462 to hotel 470 of FIG. 4, the map database 122 of FIG. 1 would identify the candidate air blocks for properties, e.g., the property 460 and others, and road segments 401-403 corresponding to the candidate route of flightpath 480.

After determination of the candidate air block(s), the UAV manager 120 requests the candidate blocks during step 1004 by sending a block request (e.g., one of block requests 613, 713, and 813) to the air block license manager 130 of FIG. 1. The licenses database 1020 (which may be a portion of air block permissions database 123) will note the candidate air blocks requested and indicate their availability in an offered block license reply message (e.g., reply messages 614, 714, and 814). During step 1005, a determination occurs as the availability of all of the required candidate air blocks. This determination can use pending license database 1020, or can occur in response to a block reply message that allows all requested blocks.

If during step 1005, the determination finds a lack of availability of all the requested candidate air blocks, then during step 1008, the UAVMS 121 may retain all of the previous candidate route, but request air block licenses for an alternate time; or determine an alternate candidate route that replaces all or a part of the previous candidate route, retaining only portions for which air block licenses are available. The UAVMS 121 will release any previously available air block no longer needed for the alternate candidate route. The UAVMS 121 could accomplish such release with a block release message (not shown) occurring prior to a commit license message, e.g., commit license messages 617, 717, and 817, after which the process 1000 loops back to step 1004.

However, if during step 1005, all the required candidate air blocks remain available, then during step 1006, the UAVMS 121 will propose a resulting route (or operation area) in a route reply message (e.g. one of route reply messages 615, 715, and 815), to the UAV 101 or the UAV operator 111, which if declined thereby (a message not shown in FIGS. 6-8) results in returning to the processing to the step 1008. If the UAV accepts (e.g., by transmitting a corresponding accept route message for receipt by the UAVMS 121), then the process 1000 advances to step 1009 whereupon the UAVMS sends a corresponding commit license message (e.g., commit messages 617, 717, and 817) to the air block license manager 130. The air block manager 130 stores the corresponding air block license information in the air block permissions database 123 and transmits a permission message (e.g., permission messages 618, 718, and 818) to the UAV 101 or the UAV operator terminal 111. Note that the possibility exists that during step 1009, some air block license offers have expired due to limited pendency, e.g., the UAVMS 121 needed to accept those licenses within a specified interval, or if other block requests (not shown) competed for licenses to the same air blocks and another entity accepted them first. Under such circumstances, the process 1000 of FIG. 10 may need to branch back (not shown) to step 1008 to determine an alternate candidate route corresponding to a re-request of candidate air blocks during step 1004. This configuration helps to reduce opportunities for deadlock, where delays by the UAVMS 121 might otherwise prevent acquisition of too many air block licenses without committing to them. Note also that for some embodiments, if the response to the block request issued during step 1004 indicates the availability of all requested air blocks, then the UAVMS 121 can presume acceptance of the proposed route and commit to the available air block. Thus, from step 1005, processing could proceed directly to step 1009 to store and provide permissions.

Having sent the permissions message, it remains for the UAV manager 120 to monitor the corresponding flight activities in the following steps, with the desired intent that the UAV manager release air block licenses as soon as they are no longer needed. The UAVMS 121 will record (e.g., log) any violation reports received (e.g., violations 642, 742, and 842) during step 1010 for appropriate handling (which could include notifying the air block license manager 130 (not shown)). During step 1011, a check occurs whether activity completion has occurred, as signaled by receipt of one of completion message 670, 770, and 870 from the UAV 101 or the UAV operator 111. When the activity has not completed, then the process 1000 proceeds to step 1012, during which, a check occurs for the receipt of progress report messages 632 and 732, and from the UAV 101 or the UAV operator terminal 110 that indicate the lack of any further need for certain block licenses (i.e., the UAV 101 has traveled past the air space associated with such licenses during flight). If so, then during step 1013, release of unneeded air block occurs with block release messages 633, 733 and 833 sent to air block license manager 130 after which or otherwise, processing continues during step 1010. If an air block license has expired before the UAV 101 has clear the corresponding air space or released the air block and a progress report (e.g., progress reports 632, 732, and 832) subsequently indicate that the UAV 101 still occupies the air block after the license is expired, then during step 1010, the UAVMS 121 will record a corresponding violation. During step 1011, the UAVMS 121 will generate an activity completion message in response to receipt of a completion message (e.g., activity complete messages 670, 770 and 870) from the UAV 101 or the UAV operator 111 and thereafter release any active air block licenses remaining with block release message 671, 771, and 871 sent to air block license manager 130 during step 1014, after which the UAV management process 1000 concludes at step 1015.

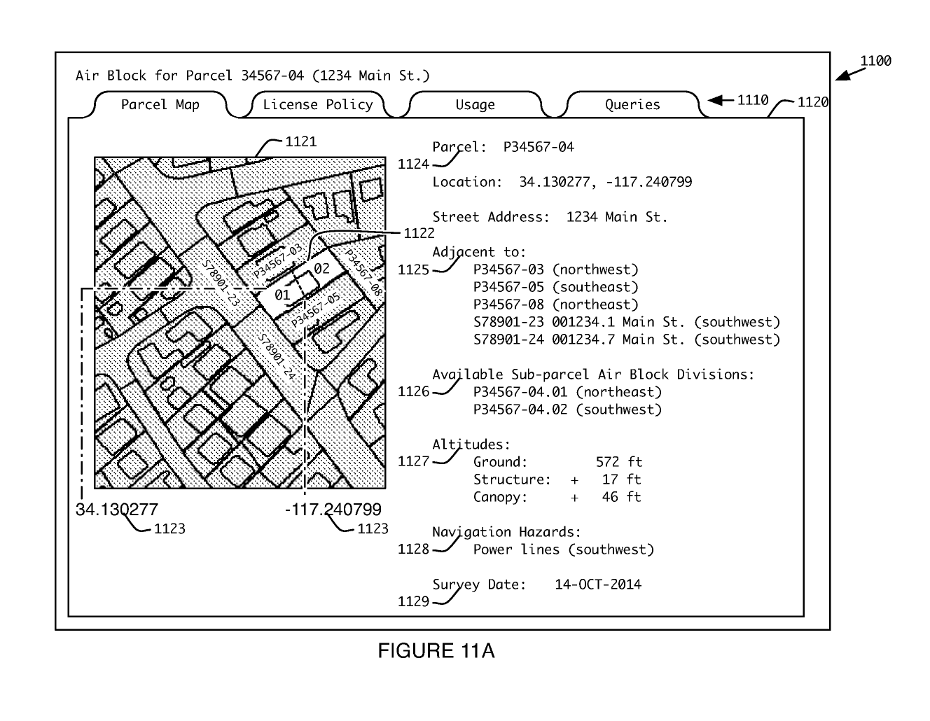

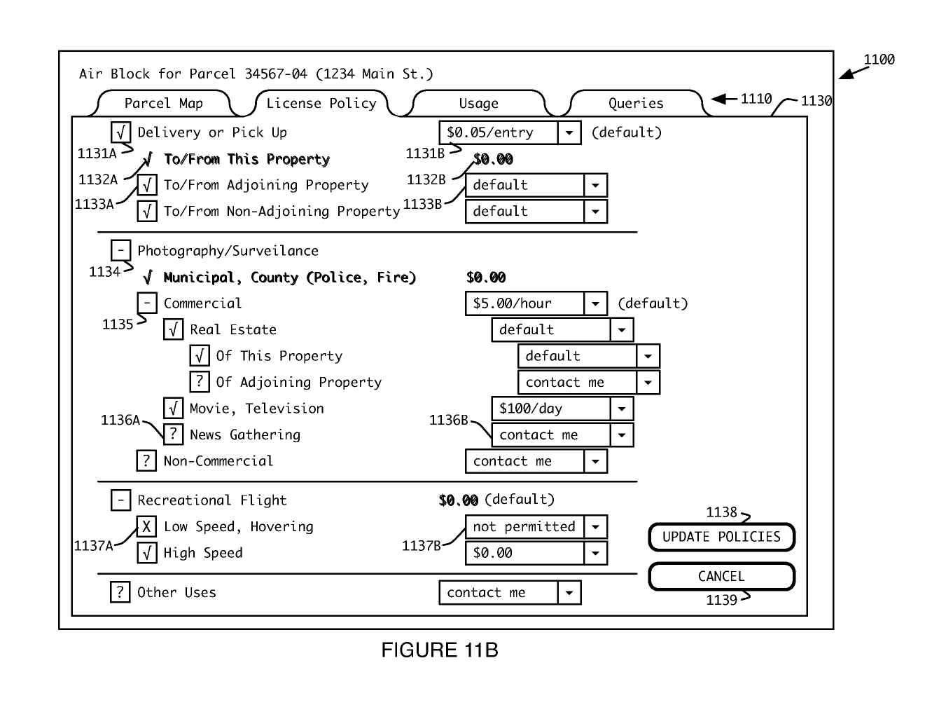

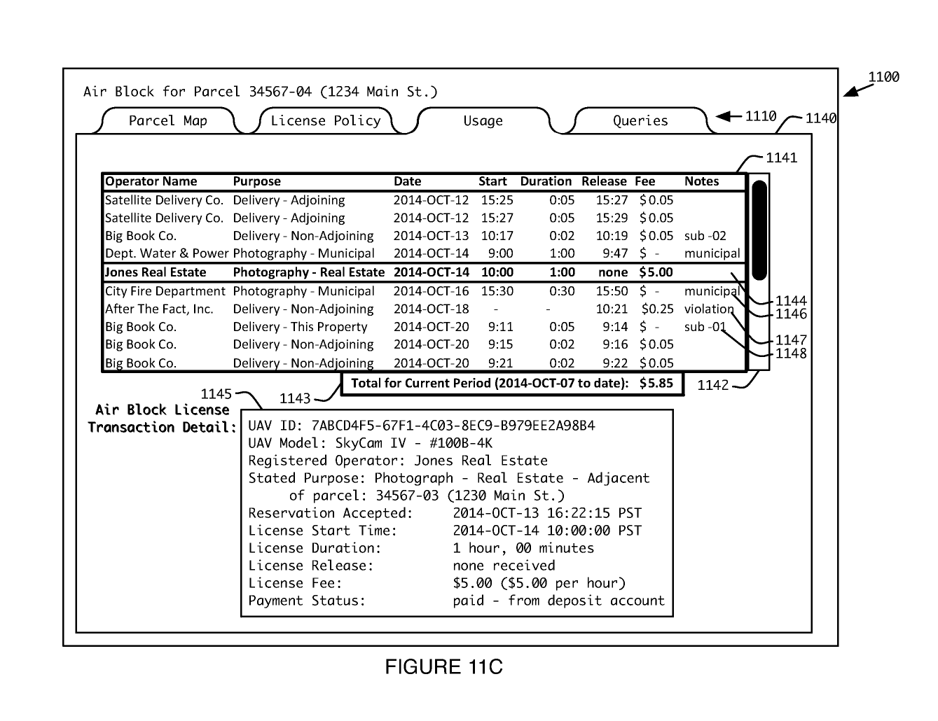

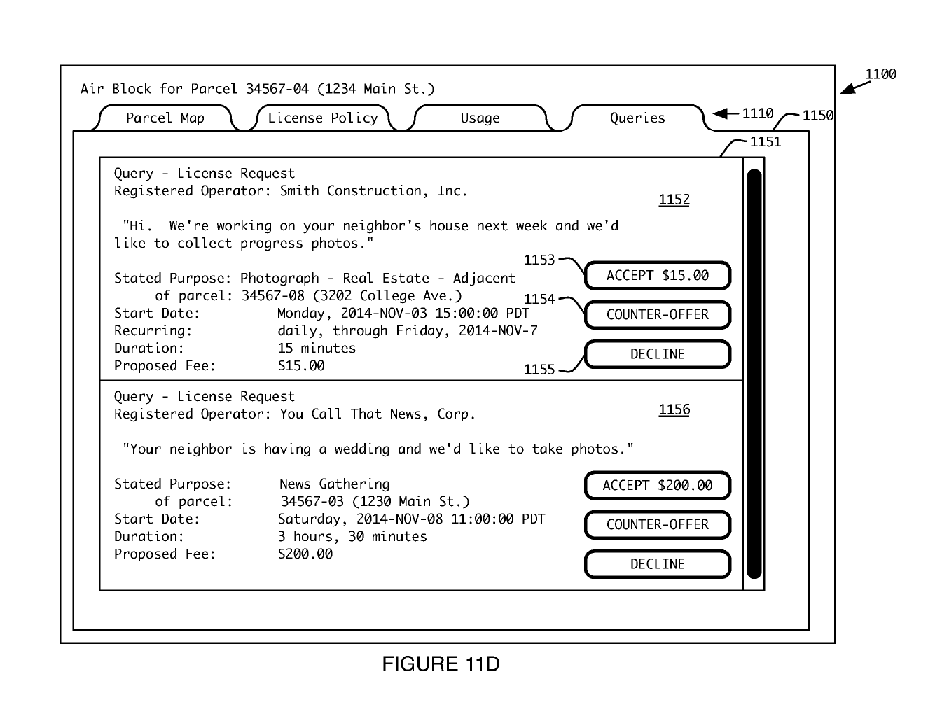

FIGS. 11A-D illustrate exemplary user interfaces as possibly provided by air block license server 131 via the air block owner terminal 140 to an air block owner 141, all of FIG. 1. In one exemplary embodiment, the air block owner terminal 140 comprises a web browser application interacting via the network 103 with the air block license server 131, which comprises a web service, to display an air block management web page providing an air block management interface 1100. In each of the interfaces depicted in FIGS. 11A-D, the exemplary parcel (e.g., parcel No. 34567-04) identified by the interface corresponds to an air block record in the table 520 of FIG. 5. The air block license server 131 presents the user interface in FIGS. 11A-D to either the corresponding air block owner 141 associated with that record and identified by the owner relationship 521A, or to the property manager (if any) associated with that record and identified by the property manager relationship 521B.

FIG. 11A depicts an array of tabs 1110, including a tab denominated as “parcel map”, which when selected, effects a “parcel detail” view 1120 illustrating the air blocks associated with a specific property (i.e., parcel 34567-04), corresponding to the AirBlockID field of the air block record in table 520, also shown as identifier 1124. The parcel detail view 1120 includes a map 1121 including a parcel diagram 1122, located by coordinates 1123 (in this embodiment expressed in latitude and longitude). Properties listed in an “adjacent to” list 1125 can come from route hints table 550. Each entry in adjacent-to list 1125 also indicates the direction from the parcel to the adjacent property, as possibly indicated in the direction field of the route hints table 550. In this example, the map 1121 explicitly identifies the corresponding adjacent properties and road segments. The street address for the parcel appears both in parcel details view 1120 and at the top of the air block management interface 1100. The individual entries for road segments in adjacent properties list 1125 give fractional street addresses for the entry point to parcel 1124 from each of the corresponding road segments S78901-23 and -24 (which correspond to road segments 202 and 203 in FIG. 2, respectively). The Parcel diagram 1122 appears broken into two sub-parcels, 01 & 02,each having separately available corresponding air block licenses, as listed in available sub-parcel air block divisions list 1126. The Altitudes list 1127 gives the elevation of a point on the property (e.g., an altitude one corresponding to map coordinates 1123) as 572 ft. The Altitudes list 1127 also lists the height of the indicated structure(s) as 17 ft. above the ground, and cautions that the canopy extends to 46 ft. above the ground. Navigational hazards list 1128 lists only power lines, along with an indication of their location (i.e., along the southwest property line). In some embodiments, the parcel view 1120 can include a notice 1129 indicating the most recent date for any (or specific) at which the details underwent updating.

FIG. 11B depicts a license policy view 1130 selected from tab array 1110. The license policy view 1130 lists various activity categories and sub-categories, indicating which are permitted or not, and license rate for each category. The checkbox 1131A indicates the availability of a license for the UAV 101 of FIG. 1 to access an air block for the activity category of “Delivery or Pick Up” with a default rate for a license of $0.05/entry into the air block, as indicated in rate box 1131B. The fixed check mark 1132A indicates a forced license for the special case of the sub-category “deliveries to or pick up from this property” for free (shown by fixed price 1132B). Other sub-categories include allowable deliveries to or pick up from an adjoining property, indicated by checkbox 1133A for the default price (shown by rate box 1133B).

In the category of “Photography/Surveillance”, licenses exist only for some sub-categories, as indicated by the dash in checkbox 1134. For the special case of the sub-category for access by “Municipal, County Emergency Services (e.g., Police and Fire)”, a default license exists for free. For the sub-category of “Commercial, the dash in checkbox 1135 indicates licenses exist only for some activities, but at a default license rate of $5.00/hour. Some hierarchical categories for real estate photography exist at the default rate, but for movies and television, the rate is $100/day. For the sub-sub-category of news gathering, licenses remain available on an ad hoc basis, as indicated by the question mark in checkbox 1136A, with an instruction to “contact me” in rate box 1136B. In some cases, the air block owner 141 of FIG. 1 can forbid a particular activity, as shown by the “X” in checkbox 1137A for the category of “Recreational Flight” in the sub-category of “low speed, hovering”. If the air block owner 141 using the license policy view 1130 has changed any of the settings (e.g., the checkboxes or rate boxes), then a press of the update policies button 1138 will commit these changes, while a press of the cancel button will cause the ABLS 131 of FIG. 1 to ignore the changed settings and cause them to revert to their prior setting.

In some cases, law or policy may mandate certain activities policy of the air block manager 130, and these appear in the interfaces accordingly. For example, allowing the UAVs a free license for photography or surveillance by a municipal police or fire department may constitute a legal requirement clearly identified. Similarly, a policy decision to force a price of $0.00 for UAV deliveries to a property makes sense because it eliminates a circular transaction in which the property owner or manager charges a delivery company for a license, but the vender then adds that license cost to the shipping fee paid by the purchaser. In some embodiments, the ABLS 131 can set “default” prices that might be fixed, or at least initialize them and thereafter periodically update the prices at regular intervals. In some embodiments, the property manager (as determined from relationship 521B in FIG. 5), can set “default” and other for properties it manages in a region. In some embodiments, the system 100 of FIG. 1 could establish a de facto property manager for certain air block records in table 520. The de facto property manager would manage properties for one or more property owners until such time as the owner(s) interacts with air block manager 130 through the air block owner terminal 140. Establishing a de facto property manager has value particularly when many air block owners lack interest or appear initially unconcerned. When property owners initially log into the ABLS 131 of FIG. 1, such property owners can become overwhelmed with the many details and options, but with the establishment of a de facto property manager, the block license manager 130 can operate and conduct business (i.e., issue licenses) on behalf of such property owners. The air block license manager 130 may already have collected license fees. Additionally, a portion of that fee might accrue to the entity operating the air block manager 130 (which could be the county or municipality or other governmental body), which could amount to a tax on UAV operations over private property managed by the ABLS 131, in addition to the revenue the municipality might garner from licenses for air blocks over road segments, and other municipal properties.

As discussed above, some activities require contact with the property owner/property manager prior to grant of an air block license, (as with “news gathering” and rate box 1136B), Thus, when a prospective air block licensee makes an activity request (e.g., activity request 611 in FIG. 6) identifying a corresponding activity, the UAVMS 121 sends that block request 613 to the ABLS 131. In the case of the need for prior contact, the ABLS 131 will return a failed block reply (not shown) to the UAVMS 121, carrying information appropriate to “contact me” policy, e.g., contact information corresponding to the air block (found in the contact info field of the account table 510 in the record corresponding to the owner relationship 521A or the property manager relationship 521B for the air block, as shown in FIG. 5). In cases where faster response becomes desirable, the UAVMS 121 could automatically attempt to route around the air block whose license policy for the activity requires prior contact. However, when the UAVMS 121 finds no other acceptable route or property, the UAVMS sends the contact information (not shown) to the UAV operator 111 to make contact as described above to explain the situation and/or negotiate a license.

FIG. 11C depicts a usage view 1140 selected from tab array 1110. The usage view includes a Licenses list 1141 that incorporates a summary listing of licenses issued for air blocks associated with the particular parcel which a user can scroll using a slide control 1142. License details 1145 appear for a selected license, e.g., license 1144 in the licenses list 1141. Fee assessed and/or paid can also appear, including a total amount 1143. Air block licenses, e.g., air block 1146, to municipal or other civil authorities typically garner no fee. The ABLS 131 typically receives violation reports (e.g., violation reports 642, 742, and 842), presented as violation report 146 in FIG. 11D, where the fee for a violation could exceed a regular license fee. Other penalties could also apply.

In some cases, a UAV operator may have an outstanding agreement with an owner 141 for air block licenses. For example, in FIG. 11C, a UAV operator “Big Book Co.” has a pre-arranged agreement with an owner for a predetermined number of UAV entries onto the owner's superadjacent airspace for any delivery activity. The predetermined number of entries, e.g., ten, might occur at regular intervals, e.g., each calendar month. Each access of the owner's air blocks by UAV operator's UAVs within the agreed period would decrement the number of remaining pre-arranged licenses, such that after use of the last license (indicated by the entry 1148 in FIG. 11D, the ABLS 131 will bill subsequent air block license at their normal rate. In some cases, the pre-arranged license agreement could provide for an unlimited number of air block licenses or be unlimited in number but limited for a short period of time (e.g., within half an hour either way of a delivery made to the property). A corresponding digital certificate typically accompanies such agreements and identifies the number and/or interval for pre-arranged air block licenses, and the permitted activities. Thus, at the time owner 141 places an order with Big Book Co., the UAVMS 121 can create a digital certificate tied to the transaction for Big Book Co., the digital certificate tendered to the ABLS 131 when arranging for the delivery flight. When used, the digital certificate will function in lieu of payment for the designated number of air block licenses from the owner over the designated interval. Thus, in license list 1141 (disregarding the countdown notes like “sub-01”), a UAV-based delivery made to the property under license 1148 becomes free to the UAV operator (in accordance with the checkmarks 1132A/1132B in FIG. 11B), through an agreement and certificate such as this, so would be the next two air block licenses (two UAV entries to deliver to non-adjoining properties), since these occur within a half an hour of the delivery indicated by the entry 1148. However, the delivery from the day before will incur a fee since it falls outside the half-hour window, and thus gets charged at the corresponding rate that, as depicted FIG. 11B, constitutes the default rate indicated by entry 1131B, namely $0.05 per entry.

FIG. 11D depicts a query view 1150 selected from tab array 1110. The query view 1150 includes a query list 1151, which as depicted, has two queries 1152 and 1156, each submitted in in connection with a request for an air block license for the activities indicated in response to “contact me” request from the owner 141 (e.g., the “contact me” notation in rate box 1136B in FIG. 11B). In the case of the query 1152, the UAV operator 111 requested an air block license for the indicated parcel for an activity associated with photographing adjacent real estate, which the ABLS 131 resolved by generating the “contact me” notation. Accordingly, the ABLS 131 created the query 1152 with additional explanatory information. In this embodiment, UAV operator 111 included an offer ($15.00) which the owner 141 can: (1) accept (by actuating the button 1153), (2) decline (by actuating the button 1155), or (3) counter offer (by actuating the button 1154). Note that in the case of query 1152, the request license has a five-day duration, limited to fifteen minutes per day. If accepted, the UAV operator 111/UAV 101 would receive an allocation applicable to a fifteen minute air block license on each of the five days requested. Alternatively, the UAV operator 111/UAV 101 could separately request air block licenses for each of the five flights with the actual flight interval resolved for each request when received. In other cases, the UAV operator 111/UAV 101 will receive an air block license for the specific time requested responsive to the query 1156 if accepted, assuming there are no conflicts with other previously granted air block licenses

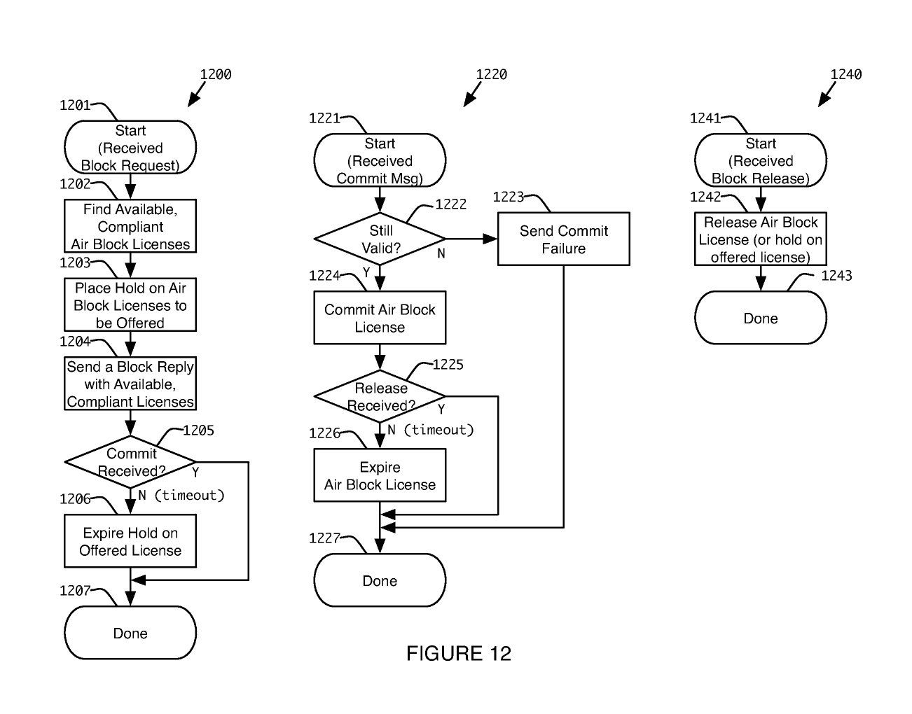

FIG. 12 is shows several flowcharts of exemplary processes 1200, 1220, and 1240 for use by the air block license manager 130. The Air block license request handling process 1200 constitutes one approach for handling air block request messages (e.g., messages 613, 713, and 813). The Air block license commit handling process 1220 constitutes an exemplary approach for handling air block license commit messages (e.g., messages 617, 717, and 817). The Air block license release handling process 1240 constitutes an exemplary approach for handling air block license releases.

The air block license request handling process 1200 begins upon execution of step 1201 during which the air block license server 131 of FIG. 1 communicates with the UAV manager 120 of FIG. 1 to receive an air block license request message (e.g., messages 613, 713, and 813 of FIGS. 6, 7 and 8, respectively)). During step 1202, the ABLS 131 of FIG. 1 queries the air block database 132 of FIG. 1 for licensable intervals for air blocks compliant with the request received. In some embodiments, the ABLS 131 accomplishes this task by a simple comparison. The ABLS 131 first identifies an air block in the received request, along with an activity category and the requested interval. During step 1202, the ABLS 131 determines the availability of that air block for licensing for the requested activity and interval. If so, then during 1203, the ABLS 131 places a hold on the offered air block license for that interval and records that hold in the air block database 132. The hold may have a timeout after which the hold expires. During step 1204, the ABLS 131 sends an offered air block license reply message (e.g., messages 614, 714, and 814) to the requesting the UAV manager 120 indicating the availability of the offered air block license.

During step 1205, the ABLS 131 determines whether it received a commit message corresponding to that offered air block license (see process 1220) before the hold expired. If so, request handling process 1200 terminates during step 1207, otherwise, during step 1206, the ABLS 131 releases the hold on the offered air block license upon expiration of the hold. Generally, even though the ABLS 131 releases the hold, a record of the offered air block license may persist for some time, which is valuable if the ABLS 131 receives a delayed commit to that air block license which it can still fulfill. In some embodiments, as an implementation choice, if all requested air block licenses are found and offered in the block reply message, there may be a presumed commit. In some embodiments, the processing during step 1202 could have greater complexity.

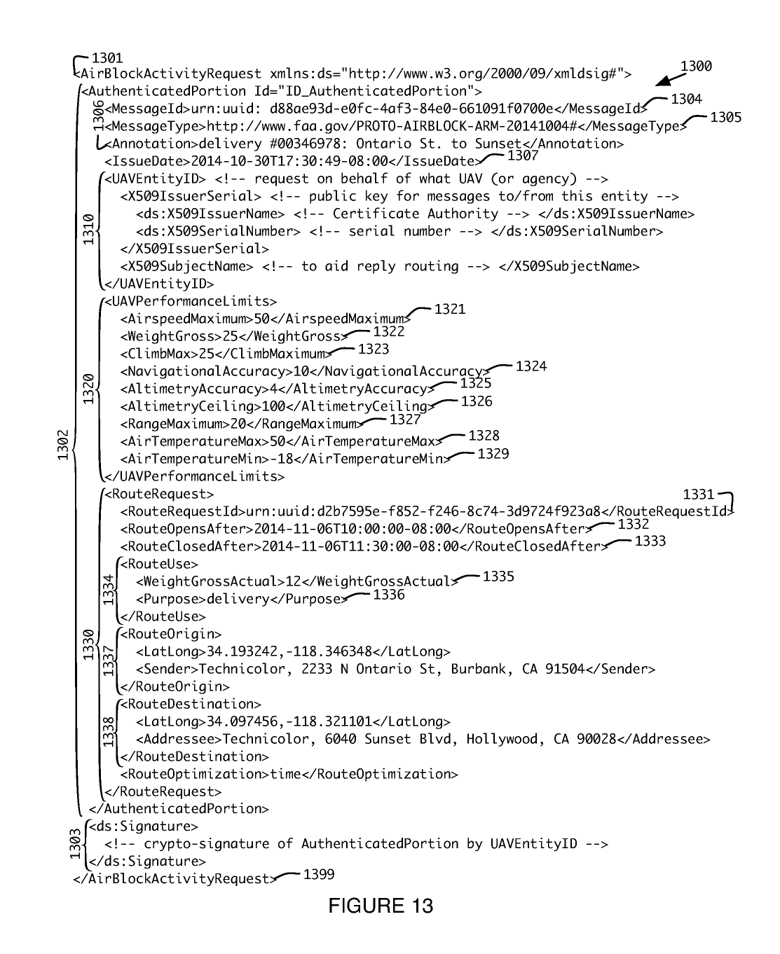

For example, the block request message received during step 1201 could list a sequence of air blocks corresponding to a flightpath and the air block license manager 130 may search for a series of corresponding air block licenses that overlap sufficiently to permit the UAV requesting the licenses to navigate the flightpath, as discussed in greater detail below in conjunction with FIG. 13.

For situations where a commit to the offered air block licenses is not presumed, the exemplary offered air block license commit handing process 1220 can activate the license, beginning with step 1221 at which time the ABLS server 131 communicates with the UAV manager 120 and receives therefrom an offered air block license commit message (e.g., messages 617, 717, and 817). During step 1222, the ABLS 131 determines whether the received commit message corresponds to an offered air block license, now the “pending air block license”, for which a hold has not expired, or otherwise still remains available. An offered air block license previously sent in step 1204 can have an identifier, either associated with each particular air block license being offered or associated with the offered air block license message overall. In those embodiments in which the ABLS 131 offers such license offers with a hold, if during step 1222 the hold has not yet expired, the air block license offer remains valid. Even if the hold has expired, in some instances, the ABLS 131 can issue the pending air block license immediately because no conflicting licenses exist for the same air block, whether pending in a hold or committed and granted, where a conflicting license would exist one for the same air block having an interval that at least partial overlaps. Further, for a conflicting license already offered and for which a hold exists, the ABLS 131 can postpone the determination during step 1222 until an entity has committed to the different license in which case the ABLS 131 will determine that the pending air block license no longer remains valid, or until the hold of the different license expires, in which case the ABLS 131 will determine is that the pending air block license is valid. For embodiments that never provide any hold for offered air block licenses, that is, the air block manager 130 operates in first-to-accept model of licensing (in which case, steps 1203, 1205, and 1206 are omitted), the air block manager can still make use of the process 1220 by applying the interpretation that all holds always remain expired, but if an air block is not licensed to another entity, the offer for a license may still be valid at step 1222.

If during step 1222, the ABLS 131 determines that the pending air block license lacks validity (e.g., due to expiration or conflict), then the ABLS sends a commit failure message (not shown) sent during step 1223 to the UAV manager 120 and processing completes during step 1227. Otherwise, if the ABLS 131 determines that the air block license remains valid, then during 1224, the ABLS commits the pending air block license in the air block database 132 and can send a commit acknowledgement message as a reply to the offered air block license commit message received during step 1221. The ABLS 131 now grants (issues) the air block license.

During step 1225, the ABLS 131 of FIG. 1 makes a determination during the interval corresponding to the granted air block license, whether the ABLS has received a release message (see process 1240), and if so, processing immediately completes during step 1227. However, if the interval for the granted air block license lapses without receipt of a release message, then during step 1226, the ABLS 131 marks the air block license as expired in the air block database 132.

The air block license release handling process 1240 begins upon execution of step 1241 whereupon the air block license server 131 receives an air block license release message (e.g., one of messages 633, 671, 733, 771, 833, and 871) from the UAV manager 120. Upon receipt, those air block licenses indicated in the message undergo marking for release in the air block database 132 during step 1242, making the corresponding air blocks immediate available for further licenses. Processing concludes during step 1243.

No strict requirement exists for the UAV manager 120 to send air block license release messages. However, such messages provide a record and an assurance that the licensed user of an air block has vacated the air block, and in some circumstances, such release messages can improve the utilization of the air block (and correspondingly, revenues attributable to it) by explicitly freeing the resource to make it available sooner for other potential users.

FIG. 13 depicts an exemplary embodiment of an activity request message 1300, provided as an XML file, which could implement the activity requests 611, 711, or 811. In this example, the activity request bears the formal designation “AirBlockActivityRequest” and is bracketed by corresponding tags 1301 and 1399. The Activity request message 1300 comprises an authenticated portion 1302 and a conventional crypto-signature 1303 usable to confirm that authenticated portion 1302 remains free from tampering and comes from the entity identified in the section 1310. Those skilled in the art will recognize the declaration of “ds” namespace in opening tag 1301 and used in entity identification section 1310 and in signature portion 1303 corresponds to the standard XML digital signature namespace defined by the World Wide Web Consortium having offices in Cambridge, Mass.

The message identifier 1304 uniquely identifies a particular activity request message 1300. In some embodiments, an activity request expressed in XML may describe itself as having a particular type 1305, in which case the activity request may comply with a particular schema as standardized by a consortium or more specific authority. To aid human-readability, the activity request can include an annotation 1306 describing the purpose of the activity request. The activity request message 1300 can include a date and time 1307 of creation to further help to distinguish between activity requests that might otherwise have the same description in the annotation 1306.

The entity identification section 1310 could correspond to a particular the UAV, especially in the case where the activity request message 1300 constitutes an embodiment of an activity request like activity request 711 issued by the UAV 101 itself. In other cases (like activity requests 611 and 811, where the request comes from the UAV management terminal 110 under the control of the UAV operator 111), the entity identification section 1310 can correspond to any certified authority, which could comprise the UAV operator 111, or the company for which the UAV operator 111 works, or the company that owns the UAV 101. However, any of the activity requests 611, 711, and 811 of FIGS. 6-8 could use any appropriate certified authority in the entity identification section 1310. However, the digital signature portion 1303 should provide an appropriate crypto-signature to authenticate that the message is actually being issued by the entity so claimed.

The UAV performance limits section 1320 provides information about the UAV 101 useful in determining whether the UAV has sufficient performance to qualify for a particular air block, just as certain terrestrial vehicles lack the performance to qualify for travel on certain highways. For example, certain high speed limited access highways (freeways and interstate highways, for example) ban bicycles or mopeds they cannot achieve a high enough speed to avoid disrupting traffic flow while allowing motorcycles and cars. In a similar manner, the UAV management system 120 or air block licensing manager 130 can use the performance constraints associated with an air block (e.g., the performance constraints field in the air block table 520 in FIG. 5), to determine whether or not a particular the UAV 101 qualifies for a license to a particular air block. For example, some air blocks, e.g., over bridge road segment 402, might be constrained to fast-moving traffic only (or that such restrictions apply during certain peak flow times), since the road segment 402 of FIG. 4 represents a north-south bottleneck in the map portion 400 (FIG. 4) and a too-slow the UAV might undesirably cause a substantial backup in air traffic. For this reason, the activity request 1300 includes an entry 132 specifying the maximum airspeed of the UAV 101. The units of measure for determining air speed may make use of a standard, thus measuring the air speed 1321 in kilometers/hour, or the air speed entry in the activity request could specify a specific unit of measure (not shown). Alternatively, the air speed information enable determination of a reasonable interval for an air block license, taking into account the time required for the UAV 101 to traverse a property in an air block, assuming the UAV travels at its maximum speed or a predetermined fraction thereof, or at a listed cruising speed (not shown), further accounting for expected head- or tail-winds.

The activity request also includes a gross maximum weight rating 1322, for the UAV 101, typically measured in herein kilograms. The gross maximum weight rating comprises the tare weight of the UAV 101 plus the maximum allowed weight of a payload (if any). The stated performance parameters for the UAV should take account of payloads up to and including the maximum allowable payload amount.

The activity request includes a maximum vertical climb rate 1323 for the UAV 101, as measured in meters/minute, using measurement units corresponding to the maximum airspeed maximum 1321, but in the context of a vertical ascent. The maximum climb rate 1323 should account for the stated gross weight 1322. Some portions of a property's superadjacent airspace could have a designation as a shaft-shaped air block, used by UAVs to climb or descend alongside a building while on approach to land on the top of that building. The climb rate depends on the UAV airspeed and remains affected by up- or down-drafts. In some instances, a UAV may need to reduce its climb rate to compensate for lateral winds. Accordingly, the climb rate can also serve to determine an appropriate interval for an air block license, by determining the expected amount of time that he the UAV 101 will need. Alternatively, in a high traffic situation, slow climbing the UAVs might not receive air block licenses. Using the maximum climb rate 1323 in conjunction with maximum airspeed 1321 could enable calculation of an expected airspeed up or down a grade, e.g., the expected air speed on a flightpath over a mountain or through a pass. Such calculations may depend on air pressure, so on hot days or at high altitudes, the airspeed and climb rates may be appropriately de-rated.

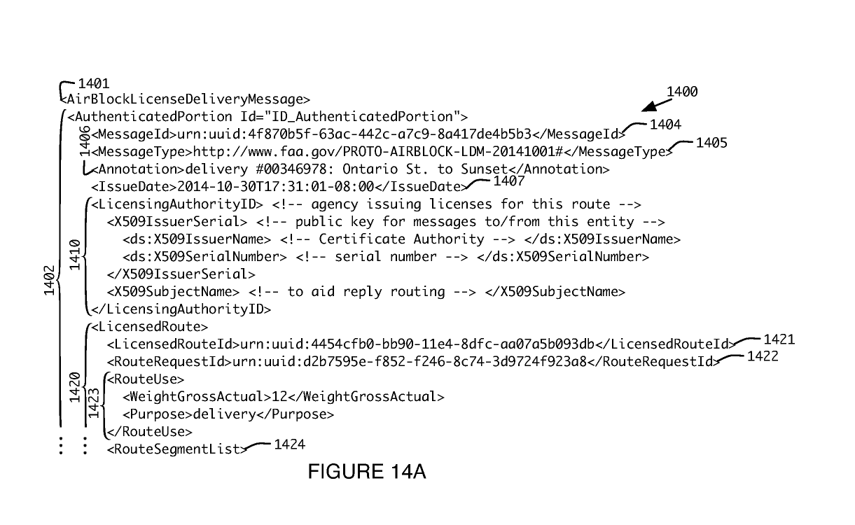

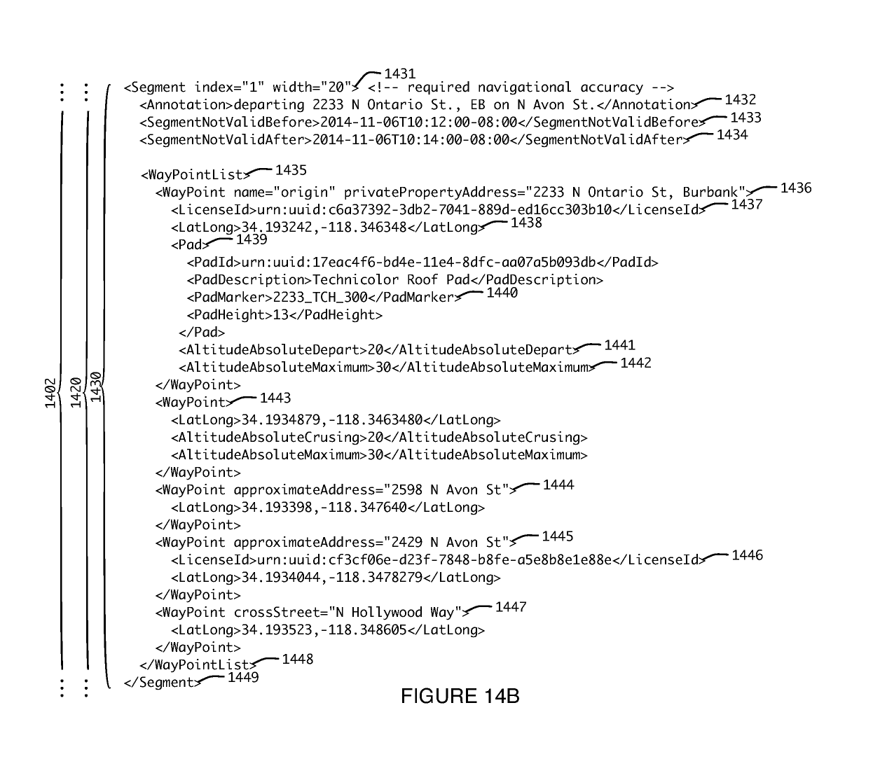

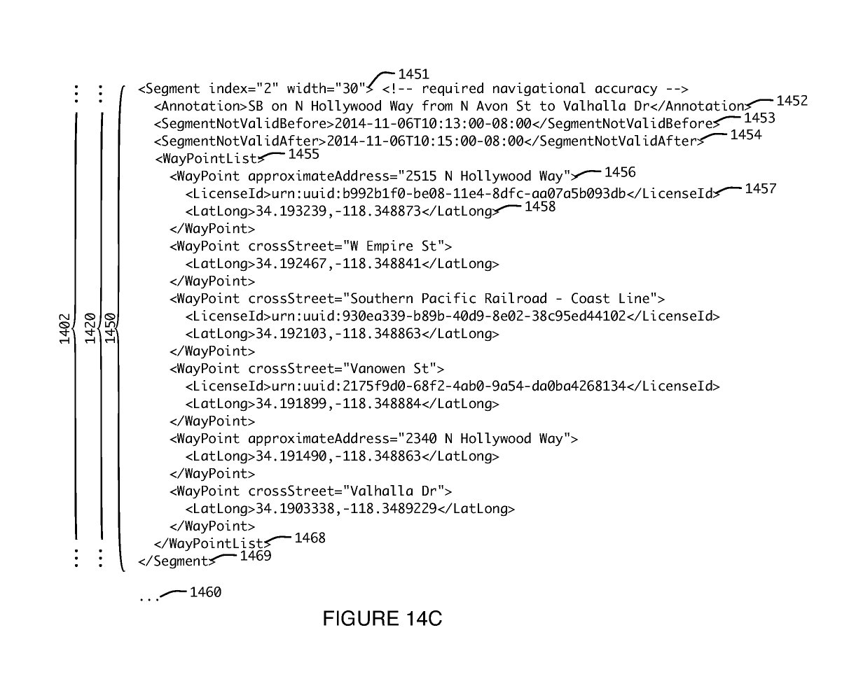

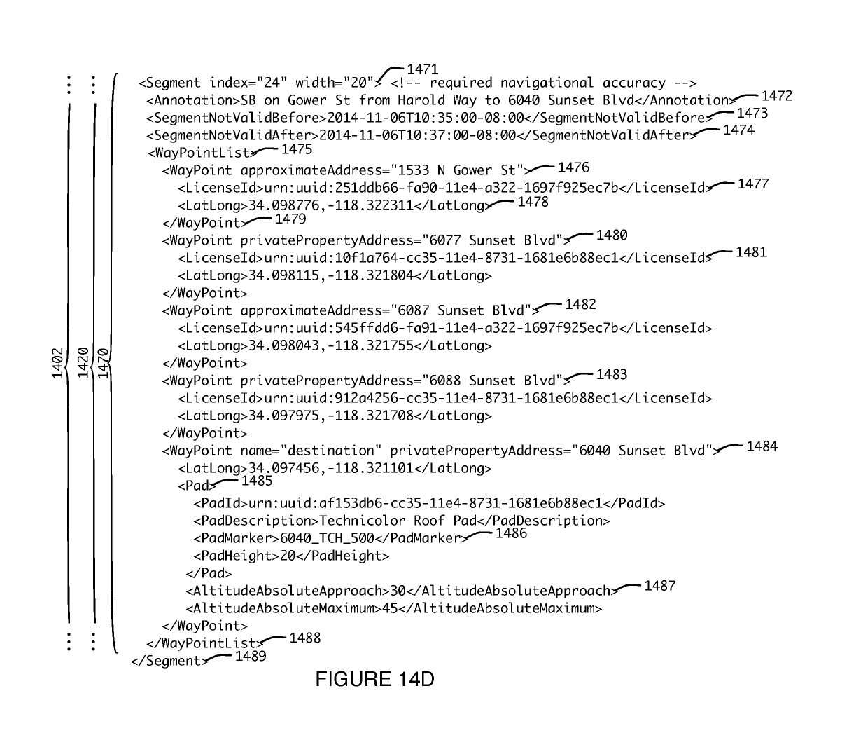

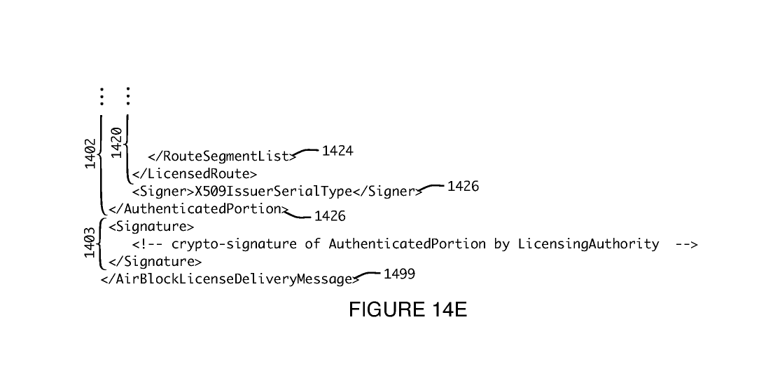

The activity request includes a navigational accuracy 1324 entry indicating the maximum expected error in absolute position that the UAV 101 might encounter, typically measured in meters. In other words, the navigational accuracy entry 1324 indicates the difference between the actual UAV position where the UAV instrumentation indicates it is. So, if the UAV 101 receives the flightpath 480 of FIG. 4 where flightpath comprises a mathematical line in 3-dimensional airspace, as might be described by a series of navigational waypoints (described below in conjunction with FIG. 14), the UAV 101 should have the ability to maintain a course along that line to within the stated accuracy, barring extreme circumstances (e.g., wind gust, smoke cloud, etc.). The activity request also includes an altimetry accuracy entry 1325, also in typically measured in meters. The altimetry accuracy value 1325 expresses the maximum expected error in determined height over the ground (or even absolute altitude), that is, the difference between how high the UAV really is and how high its instrumentation says it is. In some embodiments, an altimetry ceiling 1326 entry can describe a maximum height above ground above which the UAV's altimetry accuracy may require degrading. Such a limit may constrain height of routing of the UAV 101. Such limits might be ignored for cases of manual operation (e.g., as in manual transaction sequence 600) unless the UAV 101 lacks the ability to constrain itself to stay within the allocated air blocks and could not detect intrusion violations into unallocated air blocks (or into navigable airspace).

The activity request 1300 includes a maximum range entry 1327, here in measured in kilometers. The maximum range entry 1327 has utility for routing algorithms and would require de-rating in response to headwinds and routing delays. Too much wind in an adverse direction might leave a UAV normally able to fly a particular route without enough range, so in response to an adverse expected wind being expected, the ABLS 131 might deny an activity request. Minimum and maximum air temperature limits may define the range within which the other performance parameters remain valid. Temperatures hotter or colder than this range may lead to degraded performance (or failure). Accordingly, the ABLS 131 can deny activity requests due to weather conditions (e.g., snow, rain, fog, high winds, etc.).

The activity request 1300 includes a route request section 1330 that identifies a requested flightpath (e.g., flightpaths 231 or 241 in FIG. 2, or flightpath 480 in FIG. 4) or a requested an operation area (e.g. operation area 491 in FIG. 4). A route request has a unique identifier 1331 and describes an interval associated with that route request, typically, a defined a start time (e.g., route opens time entry 1332) and an end time (e.g., route closes time entry 1333).

The route use section 1334 in the activity request 1300 defines the intended activity by the UAV for associated with the activity request. The route use section typically includes an entry 1136 defining the purpose of the activity request (as an activity category, e.g., activity category 1131A or sub-category, etc.), along with the actual gross weight of the UAV 101 as specified in the gross weight entry 1335, which should not exceed maximum gross weight 1322. The actual UAV gross weight, as specified in the gross weight entry 1335, can serve as a criterion for selecting a route. A prohibition could exist barring UAVs above a certain gross weight from flying over certain areas. For activities such as picking up a package for subsequent delivery, the system 100 of FIG. 1 could first determine whether a UAV, such as UAV 101, laden with the package scheduled for pick up, can obtain a delivery route with the laden gross weight before bothering to obtain a pickup route where the UAV gross weight will equal the tare weight.

In some embodiments, a list of gross weights, each correlated with a single entry in lists of other weight-dependent parameters, could replace UAV parameters such as maximum gross weight 1322. This has merit when other parameters, such as the maximum airspeed specified in the entry 1321, the maximum climb rate specified in the entry 1323, or the maximum range specified in the entry 1327, dependent on the actual gross weight specified in the entry 1335. In such an embodiment, a comparison would occur between the actual gross weight specified in the entry 1335 and entries in the list of gross weights, to identify the smallest entry not exceeded by the actual gross weight. The ABLS 131 would make use of the weight-dependent parameters corresponding to that entry as needed in defining and fulfilling the activity request.

In cases where route request 1330 actually corresponds to a route rather than an operation area, the origin 1337 and the destination 1338 of the route can serve to fully define it, with the origin and destination each comprising a location specified by a latitude and longitude. In some embodiments, the origin and destination could include an annotation specifying one or more a street addresses and/or sender & addressee names, which may prove useful for routing before or after delivery by the UAV 101.

For a requested route, the UAV 101 need not necessarily have a license to every air block along the entire route for the entirety of the interval from the start time in the entry 1332 to end time in the entry 1333. Instead, the start time indicates a time at which and thereafter the UAV 101 will assuredly possess the ability to depart, and end time in the entry 1333 indicates a time by or before which the UAV 101 must complete the activity. The actual interval needed by the UAV 101 could have a considerably shorter duration than the requested interval between the start and end times. Instead of requiring the whole interval, the UAVMS 121 could plan a route with a rolling time window, where the planned route starts with a first air block license at the origin for a first sub-interval within the whole interval (from the start time to the end time), followed by a second air block license adjacent to the origin and lying along a flightpath to the destination. The second air block license being for a second sub-interval at least partially overlapping with the first sub-interval, and so on to the destination. Ultimately, the planned route ends with a final air block license at the destination for a final sub-internal still within the whole interval, but where the final sub-interval starts later than the first sub-interval starts and is at least partially not overlapping with the first sub-interval. In this way, the license for the first sub-interval ends before the license for the final sub-interval ends. In many instances, a planned route may have two to four air block licenses active at any given instant between the start of the first sub-interval and the end of the final sub-interval. The UAV 101 will enter each consecutive air block along the route shortly after the corresponding license becomes valid as defined by the corresponding sub-interval. Likewise, the UAV 101 will exit each air block along the route before the corresponding license (and sub-interval) expires. The ABLS 131 selects the duration of each sub-interval to provide enough time for the UAV 101 to traverse the corresponding air block, considering the UAV performance limits, as specified in section 1320 and the expected conditions (e.g., weather conditions, such as wind that may affect ground speed, visibility that may affect navigational accuracy. In this regard, the ABLS 131 will also take account of temperature that may affect battery and aerodynamic performance) plus additional time to account for wait times related to entering other air blocks. For example, the UAV 101 might take a minute to cross this air block, but the next air block license does not become available for 30 more seconds so the UAV may need to slow down or actually wait in a station-keeping condition before entering the next air block.

Other activity requests might request an operation area (e.g., operation area 491 in FIG. 4) rather than a route. In such a case, rather than that the route origin route destination, specified by the entries 1337 and 1338, respectively, the activity request will provide a definition (not shown) for the desired operation area (not shown). An exemplary embodiment for such a definition might identify a circular operation area by its center 490 in FIG. 4 using a latitude/longitude pair as in route origin the entry 1337, and a radius (not shown). When requesting an operation area, the interval described by a start time, as specified by the entry 1332 and an end time, as specified by the entry 1333 represents the entirety of the duration for the operation area request. Accordingly, any corresponding air block licenses would ideally last for that entire interval and less than that interval if otherwise unavailable.

In still other embodiments, a request could include both routes and areas of operation. For example, a UAV which intends to operate in a certain operation area might need a route to that operation area from a particular origin and a route from the operation area to a destination, either the same or different from the origin. In such an embodiment, the interval defined in the request might only encompass the desired operating interval within in the operation area. Thus, UAVMS 121 would need determine a starting time of the route at the origin such that the UAV can navigate to the operation area to arrive not later than the start time of the requested interval. Likewise, the UAVMS 121 would determine an end time of the route to the destination (either the same or different from the origin) where the route back to the destination engages no sooner than end of the requested interval.

Other embodiments might provide only a location (such as the operation area center 490 in FIG. 4) for use in autonomous activities, such as dropping off a parcel. In such an embodiment, an origin, an activity location, and a destination (the same or different from the origin) are each specified as a latitude/longitude pair. An example of this kind of activity request might comprise delivery from the pizza restaurant 462 of FIG. 4 to the hotel 470 of FIG. where the origin and destination comprise the pizza restaurant landing pad indicated by the circle-end of the flightpath 480 and the activity location comprises the delivery location (a drop-off pad) at the hotel, indicated by the arrow-head end of flightpath 480. In this example, the out and back flightpath remains the same, though the UAVMS 121 need not be constrained to have the out and back portions of the flightpath be the same. For example, while laden with a pizza, the UAV 101 may have a gross weight that exceeds an activity or other constraint for some air blocks, but not when unladen. Similarly, when unladen, the UAV travel can be faster or the UAV may otherwise have better performance. So it could be the case that for the return leg of the flightpath, the unladen UAV qualifies for a more efficient flightpath than on the outbound leg, and the UAVMS could take advantage of this difference.

The UAVMS 121 receives the activity request in an air block activity request message 1300. In response, the UAVMS 121 determines a route (e.g., flightpaths 231, 241, and 480) and/or area(s) of operation (e.g., operation 491) and requests the corresponding licenses for candidate air blocks from the ABLS 131 for the requested interval, using one or more block request messages (e.g., messages 613, 713, and 813). If the ABLS 1311 denies a candidate air block license in offered air block license reply messages (e.g., messages 614, 714, and 814), then the UAVMS 121 can request an air block license for a different time or determine a new route and request an air block license for the corresponding candidate air blocks in that new route. When a block reply message (e.g., one of messages 614, 714, and 814) indicates availability of a requested air block license, the UAVMS 121 can accumulate licenses until obtaining a complete route as determined during step 1005 in FIG. 10.

In some embodiments, to make fulfillment of block requests more efficient, the block request messages (e.g., messages 613, 713, and 813) from the UAVMS 121 can include the requested air blocks with a minimum required interval for each air block. This minimum required interval (not shown) constitutes the amount of time that an air block license must provide for the UAV 101 to reliably enter and exit the air block along the planned flightpath. The block request message may also include the start and end times, as specified in the entries 1332 and 1333, respectively, and a maximum flightpath duration (not shown) based on the maximum amount of time that the UAV 101 could maintain flight during along the flightpath. This information allows the ABLS 131 to search for available licenses with a start time no sooner than start time specified in the entry 1332 for the first air block. Further, the licenses must have a duration no less than the corresponding minimum required interval and longer by any planned wait inserted by the ABLS 131, where an overlapping start time becomes available for each consecutive air block licenses along the flightpath. Likewise, the air block license duration must equal or exceed the corresponding minimum required interval, and so on, the sum of which cannot exceed the maximum flightpath duration.

In other embodiments, achieving efficient block request fulfillment occurs by replying to an initial block request with a list of times for which licenses are available for indicated air blocks, where the UAVMS 121 has the responsibility of determining a set of available air block licenses that support the flightpath. In such a case, a time limit could exist during which the UAVMS 121 must respond, within which, the UAVMS 121 holds the available licenses for response. After which time, there is no guarantee of acceptance of the UAVMS 121 response. The UAVMS 121 could accept the licenses but the ABLS 131 might have offered the licenses to another entity in the meantime. The UAVMS 121 might delay acknowledgement of acceptance until after an assured response internal for the other entity had elapsed. In an alternative implementation, the ABLS 131 may always operate on a “first claimed” policy, allowing it to grant air block licenses, indicated as available, to the first claiming entity and now become unavailable when the UAVMS 121 attempts to claim them.

As apparent from the above discussion, many choices exist for optimizing the interaction between the UAV manager 120 and the air block license manager 130, both of FIG. 1. In some embodiments, these two components could exist as a single combined entity. However, in general, separating these two components remains desirable to maintain responsiveness to different interests: The UAV manager 120 answers to the UAV owner or operator, whereas the air block license manager 130 answers to the local or regional private airspace authority. In some cases, the UAV flights may cross jurisdictions, so the UAV manager 120 might interact with different air block license managers 130 for each jurisdiction. Different the UAV managers may exist, competing with differing capabilities to attract different the UAV operators, though all must interact with the air block license managers for the appropriate jurisdictions.

Once the UAVMS 121 has acquired a sufficient collection of air block licenses during step 1205 of FIG. 12, whether committed yet or not, the UAVMS can propose the resulting route to the requestor (either the UAV 101 or the UAV operator 111, corresponding to the initiator of the activity request, (e.g., activity requests 611, 711, and 811). Thereafter, the UAVMS 121 can commit to the needed licenses for the proposed route(s) during step 1210 of FIG. 12.

FIGS. 14A-E collectively depict an exemplary embodiment of a successful route reply message 1400, provided as an XML file, which could implement any of the route reply messages 615, 715, and 815. In this example, the route reply message bears the formal designation of an “AirBlockLicenseDeliveryMessage” and is bracketed by a pair of corresponding tags 1401 in FIG. 14A and 1499 in FIG. 14E. The Route reply message 1400 comprises an authenticated portion 1402 that spans FIGS. 14A-E and a conventional crypto-signature 1403 depicted in FIG. 14E usable to confirm that the authenticated portion 1402 has not be tampered with emanates from the entity identified in the section 1410 in FIG. 14A.

Each route reply message 1400 has a unique message identifier entry 1404 that includes an identifier that specifically identifies that message. In some embodiments, a route reply expressed in XML may describe itself as having a particular type indicated in the entry 1405, in which case, the route reply may comply with a particular schema standardized by a consortium or other authority. To aid human-readability, the route reply message 1400 can include an annotation indicated in the entry 1406 to describe the purpose of the route reply message, as possibly obtained from the an annotation in the entry 1306 of FIG. 13 in the corresponding activity request to which this reply message constitutes a response. The date and time indicated in the entry 1407 lists the time and date of creation of the route reply message 1400 which can further help distinguish between route replies that might otherwise have the same description in the annotation in the entry 1406.

In this exemplary embodiment, the licensed route represented in section 1420 of FIGS. 14A-E has a unique route identifier in the entry 1421 in FIG. 14A. During step 1422, the route entry identifier in the entry 1421 identifies the corresponding route request identifier in the entry 1331 of FIG. 13 to which the route reply message constitutes a response. The route use in the entry 1423 indicating the purpose for the licensed route, comes from the route use indicated in the entry 1334 of FIG. 13 in the corresponding activity request 1300. The licensed route section comprises a list of route segments, the list beginning with the tag 1424 in FIG. 14A and ending with the tag 1424 of FIG. 14E. In the illustrated embodiment, the route section includes twenty-four segments, the first segment 1430 depicted shown in FIG. 14B, a second segment 1450 depicted in FIG. 14C, and the final (twenty-fourth) segment 1470 depicted in FIG. 14D, with ellipsis 1460 in FIG. 14C indicating the intervening segments do not otherwise appear. Each of segments 1430, 1450, and 1470 begins with segment start tags 1431, 1451, and 1471, respectively, and ends with tags 1449, 1469, 1489, respectively. The segment start tag indicates the index number of the segment in the sequence, and a width (here, in meters) designating the navigation accuracy required throughout the segment. The UAV 101 must stay within this distance of the flightpath. Each of segment 1431, 1451, and 1471 can have one of annotations indicated in the entries 1432, 1452, and 1472, respectively, to provide a human-readable description of the segment, as well as the start times listed in the entries 1433, 1453, and 1473, respectively, and the end times listed in the entries 1434, 1454, and 1474, respectively, defining an validity interval for any licenses needed for the segment.

In this example, as an implementation choice, each segment has an interval of two minutes duration and each segment interval overlaps consecutive segment intervals by one minute. Thus, from start to finish, then entire route list of twenty-four segments has a scheduled duration of twenty-four minutes, plus one minute. The one minute of overlap between consecutive segment intervals allows for the transition of the UAV 101 as it travels from the air blocks (of which it need not be aware) corresponding to the end of one segment into the air blocks at the beginning of the next segment. Thus, the difference between the start and stop times listed in the entries 1433 and 1434, respectively, of FIG. 14B comprises two minutes, defining the interval duration for the first segment 1430. The stop time listed in the entry 1434 (FIG. 14B) for the first segment is a minute after start time 1453 (FIG. 14C) for the second segment, providing the one-minute overlap.

Each of segment 1430, 1450, and 1470 comprises a waypoint list, each starting with one of tags 1435, 1455, and 1475, respectively, and ending with one of tags 1448, 1468, and 1488, respectively. In the first segment 1430, the first waypoint in the entry 1436 in the waypoint list 1435 identifies an origin for a delivery, representing the purpose identified in route use entry 1423. In practice, the origin comprises a private property address, preferably identified as a human-readable address. An air block license identifier in the entry 1437 indicates which air block license record, (i.e., which of the air block license records in license table 530 of FIG. 5), corresponds to the present waypoint in the entry 1436. This license identifier in the entry 1437 also applies to each consecutive waypoint (i.e., waypoints 1443 and 1444) until a subsequent waypoint (e.g., waypoint in the entry 1445) has a license identifier (e.g., 1446). During flight, when the UAV 101 reaches the waypoint indicated in the 1445 (with its license indicated in the entry 1446), the UAV can issue a progress report (e.g., one of progress reports 632, 732, and 832) including the prior air block license identifier in the entry 1437 so that the UAVMS 121 can issue an air block license release message (e.g., one of messages 633, 733, and 833) so the ABLS 131 can release the license.

Each waypoint has a precise location as indicated in a corresponding entry, such as entry 1438. As the waypoint indicated in the entry 1436 comprises a take-off (origin) waypoint, the way point has a pad segment entry 1439 to convey details of the take-off and landing environment at this location. In practice, the pad segment entry includes a unique landing pad identifier (the PadID), a human-readable description (useful for identifying the landing pad location). A marker entry 1440 typically includes a machine-readable indicia on the physical landing pad to aid in automatic selection and navigation, particularly if a plurality of pads exists at a location. The pad segment entry also indicates the pad height (in meters) above the general ground level, in this case, on the roof, atop a 3-story building. The licensed air blocks also include recommended departure altitude (in meters above ground level) and absolute maximum altitude. The licensed air blocks can also include a minimum altitude (none shown). As with the license identifier in the entry 1437, altitude maximums (e.g., the altitude minimum in the entry 1442), or recommended altitudes as in the entry 1441), and minimum altitudes (none shown) apply until superseded by elements in later waypoints. The waypoint in the entry 1443 has a different location than waypoint in the entry 1436, but operates under the same license, so license identifier in the entry 1437 still applies.

In an alternative embodiment, each waypoint could designate navigation constraints such as minimum or maximum altitudes, or required navigational accuracies, with such constraints applied during UAV flight to the next waypoint. In some embodiments, each waypoint can designate the air block license identifier corresponding to the flightpath to the next waypoint. When a waypoint presents an air block license identifier that differs from the previous one, the UAV can release the previous one (e.g., as initiated with a progress report to the UAVMS 121).

In some embodiments, the UAV 101 could transmit a signal representing including its own UAV identifier (corresponding to the UAV entity identifier indicated in the entry 1310). The signal could also include the license identifier under which the UAV 101 currently operates, beginning with license identifier in the entry 1437 from take-off at waypoint in the entry 1436 until the UAV has reached waypoint in the entry 1445, at which point, the UAV operates under license identifier indicated in the entry. The air block license transaction detail in the entry 1145 in FIG. 11 indicates this situation. In some embodiments, the midpoint of the flightpath portion from the waypoint in the entry 1444 to the waypoint in the entry 1445 may comprise the boundary between the two adjacent air blocks and the transition to license identifier in the entry 1446 could occur at that midpoint instead. In other embodiments, the waypoint in the entry 1445 may be located at, or very close, to the boundary, so the transition to license identifier in the entry 1446 may occur at the waypoint in the entry 1445.

Notice that the UAV 101 or the UAV operator 111 need only concern themselves with the lines connecting waypoints within and between segments, and the required navigational accuracy within each segment. The UAV 101 and/or the UAV operator 111 do not need a description of the boundaries of air blocks (outside of their minimum and maximum altitudes) at the time of flight.

In some embodiments, a license identifier could correspond to a single license that covers more than a single air block. Typically, such a “multiple” air block license would apply to air blocks having a common owner, since under such circumstances need would exist to divide revenues, as in the cases with air blocks owned by different entities. For example, a municipality might issue a single license (not shown) that covers air blocks over each of road segments 206, 201, 202, 208, and 209 of FIG. 2 all for a common interval. A list of waypoints representing flightpath 241 of FIG. 2 could present a license identifier with the waypoint representing entry over the first of these segments, i.e., into air block over road segment 206, with no subsequent license identifier until reaching the waypoint representing departure from the air block over road segment 209. Such an arrangement can have value if a cost reduction exists for grouping multiple air blocks under the same license. However, in areas where or at times when high congestion exists, the ABLS 131 could choose to issue individual “per air block” licenses, and perhaps more tightly schedule their intervals to facilitate more rapid release and more efficient use.

The second segment in the entry 1451 FIG. 14C of the licensed route 1420 has a more relaxed navigational accuracy requirement (30 meters instead of the 20 meters in first segment 1431). The first waypoint in the entry 1456 at location 1458 of the second segment corresponds to an air block license identifier in the entry 1457. If operating according the licensed route 1420, the UAV 101 would transition between the first and second segments by exiting the air block corresponding to the last waypoint in the entry 1447 (FIG. 14B) of the first segment in the entry 1451 no later than the end time in the entry 1434 for the first segment, and enter the air block corresponding to the waypoint in the entry 1456 (FIG. 14C) no sooner than the start time in the entry 1453 for the second segment in the entry 1451. During this transition, the required navigation accuracy corresponds to the minimum specified accuracy for the first and second segments in the entries 1431 and 145, which happens to be 20 meters, the width specified for the first segment. Since waypoint in the entry 1436 provides license identifier in the entry 1437, upon arrival at waypoint in the entry 1436 (or in other embodiments, as previously discussed, a point between waypoints in the entries 1447 and 1456, (e.g., the midway point), the UAVMS 121 can receive a progress report (e.g., one of progress reports 632, 732, and 832) including the prior air block license identifier 1446, so that the UAVMS can issue an air block license release message (e.g., one of release messages 633, 733, 833). IN response, the ABLS 131 can release the license.

The twenty-fourth segment 1471 in FIG. 14D of licensed route 1420 has a first waypoint in the entry 1476 at location in the entry 1478 and a corresponding air block license identifier in the entry 1477. If operating according the licensed route 1420, the UAV 101 would transition into this twenty-fourth segment no sooner than the start time in the entry 1473 for the segment 1471 and no later than the end time for the prior (twenty-third) segment (not shown). The final waypoint in the entry 1484 of the twenty-fourth (and final) segment 1471 of licensed route 1420, bears a tag as a “destination”. Accordingly, the pad element in the entry 1485 includes a description of the landing pad where the UAV 101 expects to make the delivery. As discussed, the description includes the pad height above ground (as measured in meters), a unique identifier, a human-readable description (helpful to an individual looking for the delivery location), and a pad marker, as indicated in the entry 1486. The pad marker in the entry 1486 corresponds to a machine-readable indicia on the physical landing pad to aid in automatic selection and navigation, particularly for locations where a plurality of pads exists. The pad description also includes a recommended altitude for approach in the entry 1487, indicating an altitude higher than the height of pad in the entry 1485.

Within the licensed route 1420, waypoints often include informative, human-readable descriptions. For example, those waypoints that correspond to air blocks over road segments, a human readable “approximate address” annotates the waypoint tag (e.g., the tags 1476 and 1482 in FIG. 14D). In some cases, for air blocks that encompass an intersection of road segments, the waypoint annotation could a designation as a “cross street” (e.g., way point annotation entries 1444 and 1447 in FIG. 14B) relative to the previously identified street address. For waypoints that correspond to air blocks over other properties, a “private property address” (which may or may not be approximated) typically appears in the waypoint tag (e.g., waypoint tags 1480, 1483, and 1484). In cases a waypoint (e.g., waypoint in the entry 1443) has no annotation, the annotation from the prior waypoint (e.g., 1436) may be presumed, as might be typical in a situation where a series of navigational waypoints describe a flightpath wending over a common parcel (as indicated by the entries 1436 and 1443).

In another scenario, where the licensed route corresponds to an operation area (e.g., operation area 491 in FIG. 4), then a route segment list (e.g., in lieu of the route segment list in FIGS. 14A-E beginning during step 1424 and ending during step 1424) could be constructed comprising one segment (similar to 1451 shown in FIG. 14C) to represent the operation area. Such a segment would comprise a single waypoint identifying the location (as during step 1458) corresponding to point 490 in FIG. 4 and having a width (as in segment tag 1451) corresponding to a radius of the operation area 491. In an alternative embodiment for supporting non-circular areas of operation, a waypoint could comprise a location list (not shown) comprising three or more locations, instead of a single location like the location in the entry 1458. The list of locations (not shown) within a single waypoint would describe a perimeter of the operation area within which the UAV 101 should remain. For three locations, the perimeter forms a triangle with the locations specifying the vertices of that triangle. Various conventions could prescribe ordering of the locations.

For example, when proceeding from one location in the list to the next, a location “inside” the perimeter corresponds to the right-hand side of the line segment between the two locations. For the last location in the list, the perimeter closes back to the first location in the list. For such an embodiment, the navigational accuracy expressed by the width parameter (e.g., in the segment tag 1451) would indicate an inset distance, that is, while inside the perimeter so defined, the UAV would maintain a distance of at least the width from all edges of the perimeter. In still other embodiments, an operation area could correspond to as a collection of such perimeters expressed as lists of locations, perhaps with each perimeter in the collected having a minimum and maximum altitude described, as would be useful to allow an operation area for flight such as operation area 491 in FIG. 4. However, low-altitude operations like take-off and landing could be limited a particular portion of road segment 406. From these descriptions, those skilled in the art will understand that descriptions for areas of operation can take many forms, not merely those explicitly described here.

In another embodiment, within the licensed route, a first series of one or more segments might provide a first flightpath for the UAV 101 to reach an operation area. After the UAV 101 reaches that operation, a single segment as discussed above, could describe that operation followed by a second series of one or more segments to provide a second flightpath for the UAV to return from the operation area. In such an embodiment, the origin and the designation waypoints could be the same. This would serve as a useful arrangement for the UAV 101 to fly from a base to an event, whereupon the area of operation is used during the event (e.g., for coverage of a sporting event, or for aerial photography as when making a movie), and afterward the UAV returns to base.

Other embodiments (not shown), could manage the transitions between segments differently. For example, a transition element could exist between segments, the transition comprising a single waypoint located within an air block for a granted license that has an interval that overlaps with those of the adjacent segments within the sequence to allow the UAV 101 to make the transition between sequence segments. Alternatively, each segment can correspond to a single air block, each single-air-block segment having an interval that overlaps with the next. Different embodiments can trade off efficient strictness of schedule vs. flexibility. For example, each air block license can lasts for as short an interval as reasonable and has a minimal internal overlap with the next air block). For greater flexibility, a group of waypoints and air blocks undergo licensing for the same interval, with ample overlap with the intervals of adjacent segments, allowing a UAV plenty of leeway in case the wind suddenly picks up. With the more flexible scheduling selected, immediate compensation for wind by the UAV might not be necessary, as it might subside a moment later, but if it persists, then the UAV can compensate. By not requiring strict adherence to a tight schedule at every waypoint, but instead over the longer intervals of a segment, a reduction in the energy consumption profile for a flightpath may occur. In some cases, a UAV manager 120 or air block manager 130 may choose between different options based on congestion. Heavy traffic may call for tighter schedules, while lighter traffic may allow for less energetic flight dynamics to keep to a tight schedule.

FIG. 15 depicts an exemplary embodiment of a failed route reply message 1500 (in contrast to the successful route reply message 1400 of FIG. 14). The failed route reply message 1500 typically exists as XML file, which could implement this message as well as each of the route reply messages 615, 715, and 815 when an activity request (e.g., one of activity requests 611, 711, and 811) cannot be granted. As above, in this example, the route reply bears the formally designation of an “AirBlockLicenseDeliveryMessage” and is bracketed by corresponding tags 1501 and 1599.

The route reply message 1500 comprises an authenticated portion 1502 and a conventional crypto-signature 1503 usable to confirm that the authenticated portion 1502 has not been subject to tampering and emanates from the entity identified in the section 1510. Each route reply message 1500 has a uniquely identifier in the entry 1504 that specifically identified that reply message. In some embodiments, a route reply expressed in XML may describe itself as having a particular type as specified in the entry 1505, in which case the route reply may comply with a particular schema standardized by a consortium or more specific authority (e.g., the Federal Aviation Administration). To aid human-readability, the route reply message can include an annotation in the entry 1506 to describe the purpose of the route reply, typically obtained from the annotation in the entry 1306 of FIG. 13 in the corresponding activity request to which this reply message constitutes a response. The route reply message can include the date and of its creation, as specified in the entry time 1507 to further help to distinguish between route replies that might otherwise have the same description in the annotation in the entry 1506.

For the exemplary failed route reply message 1500 of FIG. 15, the licensed route 1520 contains no data (i.e., the entry is empty). In other words, no licensed route has been returned, and no corresponding air block licenses issued. Instead, an explanation section 1530 provides information as to why the ABLS 131 could not fulfill the activity request. The “Summary” portion 1531 provides a brief, human-readable summary of the failure. A failure list 1532 enumerates individual failures 1540 and 1550, providing more information, as by identifying a precise failure category (i.e., failure kind) 1541 and 1551, and a more detailed failure message 1542 and 1552 for presentation to the UAV operator 111. The failure in the entry 1540 includes a classification of the failure kind in the entry 1541. For example, the failure kind could include “Flight Restriction: Navigation Requirement: Daylight Requirement” which occurs if the UAV cannot navigate or otherwise operate without adequate light. The corresponding detailed failure message cites the local time at which civil twilight occurs, at which time restrictions are imposed, interfering with the interval associated with the activity request. The Failure 1550 includes the failure kind 1551, “Flight Restriction: Weather Requirement: Wind” which occurs if expected winds along routes or in the area of operation requested exceed UAV performance limitations (not shown) in performance limit section 1320 in FIG. 13 of the activity request 1300 and the corresponding detailed failure message 1552 elaborates on this. In some cases, even though the UAV operate given the forecasted winds, a route normally achievable by the UAV 101 may become impossible, or merely too risky, given a loss in airspeed due to headwinds, or the extra exertion required by the UAV to maintain course with crosswinds, with a corresponding failure being returned.

The foregoing describes a technique for managing the allocation of air space for access by unmanned aerial vehicles (UAVs).

1. A method for automatically managing air space for at least one unmanned aerial vehicles (UAV), comprising:
receiving a request associated with the at least one UAV, the request having at least one characteristic associated with UAV operation, to access a defined air space having at least one associated requirement;
determining if the at least defined air space to be accessed by the UAV is available and if the at least one characteristic of the at least one UAV matches the at least one requirement of the defined air space, and if so, then
granting a license to the UAV to authorize to entry to the UAV into the defined air space.

2. The method according to claim 1 wherein the request originates from the UAV.

3. The method according to claim 1 wherein the request originates from an operator of the UAV.

4. The method according to claim 1 wherein the at least one characteristic associated with UAV operation includes an activity request indicative of an activity for which UAV access to the defined air space is sought.

5. The method according to claim 1 wherein the at least one characteristic associated with UAV operation includes an origin of UAV departure and a destination for UAV arrival.

6. The method according to claim 1 wherein the at least one characteristic associated with UAV operation location of a UAV operating area.

7. The method according to claim 1 wherein the at least one characteristic associated with UAV operation includes a UAV operating parameter.

8. The method according to claim 1 further including releasing the air block license following completion of UAV activity within the defined air space.

9. A method for automatically managing air space for at least one unmanned aerial vehicles (UAV), comprising:
generating a request associated with the at least one UAV, the request having at least one characteristic associated with UAV operation, to access a defined air space having at least one associated requirement;
receiving a license for entry of the UAV into the defined air space following a determination whether the defined air space to be accessed by the UAV is available and if the at least one characteristic of the at least one UAV matches the at least one requirement of the defined air space.

10. The method according to claim 9 wherein the UAV generates the request.

11. The method according to claim 9 wherein an operator of the UAV generates the request.

12. The method according to claim 9 wherein the at least one characteristic associated with UAV operation includes an activity request indicative of an activity for which UAV access to the defined air space is sought.

13. Apparatus automatically managing air space for at least one unmanned aerial vehicles (UAV), comprising:
a UAV management server configured to (a) receive a request associated with the at least one UAV, the request having at least one characteristic associated with UAV operation, to access a defined air space having at least one associated requirement; (b) determine if the at least defined air space to be accessed by the UAV is available by communicating with an Air Block License Server (ABLS) which manages air block license availability, (c) determine if the at least one characteristic of the at least one UAV matches the at least one requirement of the defined air space, and if so, then (d) request the ABLS grant a license to the UAV to authorize to entry to the UAV into the defined air space.

14. The apparatus according to claim 13 wherein the request originates from the UAV.

15. The apparatus according to claim 13 wherein the request originates from an operator of the UAV.

16. The apparatus according to claim 13 wherein the at least one characteristic associated with UAV operation includes an activity request indicative of an activity for which UAV access to the defined air space is sought.

17. The apparatus according to claim 13 wherein the at least one characteristic associated with UAV operation includes an origin of UAV departure and a destination for UAV arrival.

18. The apparatus according to claim 13 wherein the at least one characteristic associated with UAV operation location of a UAV operating area.

19. The apparatus according to claim 13 wherein the at least one characteristic associated with UAV operation includes a UAV operating parameter.

20. The apparatus according to claim 13 wherein the UAV managing server releases releasing the air block license following completion of UAV activity within the defined air space.
